(19) United States
(12) Patent Application Publication
(10) Pub. No.: US 2007/0297732 A1
(43) Pub. Date: Dec. 27, 2007

(54) EFFICIENT NONLINEAR OPTICAL WAVEGUIDE USING SINGLE-MODE, HIGH V-NUMBER STRUCTURE

(75) Inventors: Thomas Beck Mason, San Jose, CA (US); Gregory D. Miller, Sunnyvale, CA (US); Mark A. Arbore, Los Altos, CA (US)

Correspondence Address: JOSHUA D. ISENBERG;JDI PATENT, 809 CORPORATE WAY, FREMONT, CA, 94539, US

(73) Assignee: Collinear Corporation, Santa Clara, CA (US)

(21) Appl. No.: 11/744,646

(22) Filed: May 4, 2007

Related U.S. Application Data
(60) Provisional application No. 60/811,848, filed on Jun. 7, 2006.

(51) Int. Cl. G02B 6/00

(52) U.S. Cl. 385/122

(57) ABSTRACT

Optical waveguide devices characterized by low loss for a fundamental mode and high loss for higher order modes are disclosed. The high loss is sufficiently high that the waveguide is effectively single-moded.

### CROSS-REFERENCE TO RELATED APPLICATION

This application claims the benefit of priority of co-pending provisional patent application Ser. No. 60/811,848, which was filed on Jun. 7, 2006, the entire disclosures of which are incorporated herein by reference.

### FIELD OF THE INVENTION

This invention generally relates to optical waveguides and more particularly to optical waveguides that are single-moded over a wide range of wavelengths.

### BACKGROUND OF THE INVENTION

Optical waveguides are physical structures that guide electromagnetic waves in the optical spectrum. Single mode waveguides with large, undoped cores are potentially useful for nonlinear optical interactions between multiple wavelengths. Unfortunately, prior art waveguide designs are not suitable for achieving single-modedness over wide wavelength ranges.

Nonlinear optics is a branch of optics that describes the behavior of light in nonlinear media, that is, media in which the polarization P responds nonlinearly to the electric field E of the light. This nonlinearity is typically only observed at very high light intensities. Examples of nonlinear optical processes include frequency conversion processes and other nonlinear processes. Nonlinear optical processes often involve interaction of widely disparate wavelengths of light.

Generally, frequency conversion is performed in second-order nonlinear optic (NLO) materials because they have strong nonlinear effects. Second order interactions may involve 2 (at degeneracy) or 3 wavelengths. For second harmonic generation (SHG) or (degenerate) optical parametric oscillation (OPO), the wavelengths differ by a factor of 2. For sum frequency generation (SFG) (or non-degenerate OPO), the shortest and longest wavelengths differ by a factor greater than 2, and in principle, could span the entire transparency range of the material used (a range that may exceed a factor of 10 in some cases). For a nonlinear material such as Lithium Tantalate, the transparency range may span from about 300 nm to about 5000 nm, depending on how transparency is defined. Generally, it is desirable to convert laser wavelengths from an “easy to produce” range near 1 micron in wavelength to one or more of the visible, UV, and mid-IR. Most good diode and solid-state laser materials typically emit light between 800 nm-1600 nm. There is great interest in generation of visible (450-650 nm) light via frequency conversion from diode lasers, hence any practical light source based on waveguide nonlinear optics may be expected to involve a wide range of wavelengths.

Common types of optical waveguides include optical fiber and rectangular waveguides. Optical waveguides are used as components in integrated optical circuits or as the transmission medium in local and long haul optical communication systems. Optical waveguides can be classified according to their geometry (e.g., slab, strip, or fiber waveguides), mode structure (single-mode, multi-mode), refractive index distribution (e.g., step or gradient index) and material (e.g., glass, polymer, semiconductor).

There are certain difficulties associated with implementing nonlinear processes in optical waveguides. Generally, waveguides can support a finite number of transverse modes (field distributions) that can propagate with low loss through the device. Generally, at shorter wavelengths, more modes are supported than at longer wavelengths. The exact shapes (and number) of transverse modes depend on the shape, dimensions, and refractive indices of the materials comprising the waveguide structure (i.e., on the boundary conditions they impose.) Various transverse modes exhibit different number of and arrangement of “lobes” and “nulls” of electric field and hence optical intensity. Nonlinear optical interactions between two wavelengths in a waveguide occur between specific combinations of transverse modes when two conditions are met: (a) phasematching or quasiphasematching, and (b) electric field overlap.

While it is, in principle, possible to phasematch or quasi-phasematch most such interactions, each combination of modes at the interacting wavelengths requires a slightly different phasematching or quasi-phasematching condition. It would be difficult, inefficient, and undesirable to design devices to simultaneously phasematch or quasi-phasematch all possible interactions between all guided transverse modes in a multi-moded waveguide structure. Typically, allowing one interaction comes at the expense of efficiency of another interaction. Even if there were no requirement for phasematching, there is still the overlap problem. The efficiency of an interaction depends on the overlap integral (i.e. similarity) between the modes in question. Generally, the best overlap occurs between the lowest-order modes. Also, multiple transverse modes at a single wavelength are strictly orthogonal to each other, and have a zero overlap.

Since the mode shapes/sizes depend slightly on wavelength, it is generally true that there exists a non-zero (but still very small) overlap between modes or different orders at different wavelengths. Hence, when one attempts a nonlinear optical interaction between two (or three) wavelengths in a waveguide that is multi-moded at one or more wavelengths, there will be a large number of possible interactions, each with a different efficiency that depends on the details of the various phasematching conditions and overlap integrals. Generally, all of these parameters are difficult to control. Hence, an unpredictable (and very inefficient) outcome typically occurs. Furthermore, the beam quality of the generated light would also be poor and unpredictable.

A common approach for dealing with this problem is to carefully control the launch condition so as to preferentially excite only the fundamental mode for each input wavelength. This is, in practice, rather difficult. Even if it is achieved, any small defect in the waveguide structure can cause significant scattering of light between the various transverse modes, thereby ruining the effect of the careful launch. Even more insidious is scattering between modes caused by optically-induced material changes. This type of defect can be automatically generated in an optimally bad (periodic) pattern that is efficient at scattering light between modes that are already present in the waveguide—thereby rendering an almost-perfect launch condition indistinguishable from a bad launch condition.

It is within this context that embodiments of the present invention arise.

### BRIEF DESCRIPTION OF THE DRAWINGS

Other objects and advantages of the invention will become apparent upon reading the following detailed description and upon reference to the accompanying drawings in which:

FIG. 1 is a graph showing the effective refractive indices of the first five guided modes as a function of core thickness in a waveguide having a step-index, slab geometry.

FIG. 2 is a graph showing the effective index difference of simple modes (same number of zero-crossings under the ridge as in the slab region) as a function of ridge etch depth in a waveguide having a step-index, slab geometry with 5 μm total thickness under the ridge.

FIG. 3 is a graph showing the effective index difference of compound modes, in which the ridge supports one more zero-crossing than the slab region, as a function of ridge etch depth in a waveguide having a step-index, slab geometry with 5 μm total thickness under the ridge.

FIG. 4 is a graph showing the effective index of compound modes, in which the ridge supports two more zero-crossing than the slab region, as a function of the ridge etch depth in a waveguide having a step-index, slab geometry with 5-μm total thickness under the ridge.

FIG. 5 is a graph showing the overlap integrals between four pairs of simple vertical modes as a function of the ridge etch depth in a waveguide having a step-index, slab geometry with 5 μm total thickness under the ridge.

FIG. 6 is a graph showing the overlap integrals between six pairs of vertical modes as a function of the ridge etch depth, in which a first mode is a fundamental (0+0, simple) and the other five modes are compound modes with one more zero-crossing under the ridge than in the slab region.

FIG. 7 is a graph showing the overlap integrals between five pairs of vertical modes as a function of the ridge etch depth, in which a first mode is a fundamental (0+0, simple) and the other four modes are compound modes with two more zero-crossing under the ridge than in the slab region.

FIG. 8A is a cross-sectional view illustrating a layer structure of an optical waveguide device according to an embodiment of the present invention.

FIG. 8B-8D are a sequence of a cross-sectional views illustrating a possible method of fabrication of an optical waveguide device of the type shown in FIG. 8A.

FIG. 8E is a three-dimensional schematic diagram of an optical waveguide device with a Bragg grating formed near one end of a ridge structure according to an alternative embodiment of the present invention.

FIGS. 9A-9B are graphs showing the Mode Loss of seven different mode groups as a function of etch depth.

FIGS. 10A-10B are graphs showing the loss associated with each of three high-order quasi-modes as a function of wavelength.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the examples of embodiments of the invention described below are set forth without any loss of generality to, and without imposing limitations upon, the claimed invention.

Glossary:

As used herein:

The indefinite article “A”, or “An” refers to a quantity of one or more of the item following the article, except where expressly stated otherwise.

Cavity or Optical Cavity refers to an optical path defined by two or more reflecting surfaces along which light can reciprocate or circulate. Objects that intersect the optical path are said to be within the cavity.

Diode Laser (or diode laser) refers to a light-emitting diode designed to use stimulated emission to generate a coherent light output. Diode lasers are also known as laser diodes or semiconductor lasers.

Ferroelectric Material refers to a class of material that exhibits a spontaneous electric dipole moment, which can be reversed by the application of an electric field.

Includes, including, e.g., “such as”, “for example”, etc., “and the like” may, can, could and other similar qualifiers used in conjunction with an item or list of items in a particular category means that the category contains the item or items listed but is not limited to those items.

Infrared (IR) Radiation refers to electromagnetic radiation characterized by a vacuum wavelength between about 700 nanometers (nm) and about 100,000 nm.

Laser is an acronym of light amplification by stimulated emission of radiation. A laser is an optical cavity that is contains a lasable material. This is any material—crystal, glass, liquid, semiconductor, dye or gas—the atoms of which are capable of being excited to a metastable state by pumping e.g., by light or an electric discharge. Light is emitted from the metastable state by an atom as it drops back to the ground state. The light emission is stimulated by the presence of a passing photon, which causes the emitted photon to have the same phase and direction as the stimulating photon. The light (referred to herein as stimulated radiation) oscillates within the cavity, with a fraction ejected from the cavity to form an output beam.

Light: As used herein, the term “light” generally refers to electromagnetic radiation in a range of frequencies running from infrared through the ultraviolet, roughly corresponding to a range of vacuum wavelengths from about 1 nanometer (10⁻⁹ meters) to about 100 microns.

Mode refers to a distribution of electric field or optical intensity for light in a waveguide.

Nonlinear Optical Process refers to a class of optical phenomena that can typically be viewed only with nearly monochromatic, directional beams of light, such as those produced by a laser. Higher harmonic generation (e.g., second-, third-, and fourth-harmonic generation), optical parametric oscillation, sum-frequency generation, difference-frequency generation, optical parametric amplification, and the stimulated Raman Effect are examples of non-linear effects.

Nonlinear Optical Frequency Conversion Processes are non-linear optical processes whereby input light of a given vacuum wavelength λ₀ passing through a non-linear medium interacts with the medium and/or other light passing through the medium in a way that produces output light having a different vacuum wavelength than the input light. Nonlinear wavelength conversion is equivalent to nonlinear frequency conversion, since the two values are related by the vacuum speed of light. Both terms may be used interchangeably. Nonlinear Optical Frequency conversion includes:
Higher Harmonic Generation (HHG), e.g., second harmonic generation (SHG), third harmonic generation (THG), fourth harmonic generation (FHG), etc., wherein two or more photons of input light interact in a way that produces an output light photon having a frequency Nf₀, where N is the number of photons that interact. For example, in SHG, N=2.
Sum Frequency Generation (SFG), wherein an input light photon of frequency f₁ interacts with another input light photon of frequency f₂ in a way that produces an output light photon having a frequency f₁+f₂.
Difference Frequency Generation (DFG), wherein an input light photon of frequency f₁ interacts with another input light photon of frequency f₂ in a way that produces an output light photon having a frequency f₁−f₂.

Nonlinear Material refers to materials that possess a non-zero nonlinear dielectric response to optical radiation that can give rise to non-linear effects. Examples of non-linear materials include crystals of lithium niobate (LiNbO₃), lithium triborate (LBO), beta-barium borate (BBO), Cesium Lithium Borate (CLBO), KDP and its isomorphs, LiIO₃, as well as quasi-phase-matched materials, e.g., PPLN, PPSLT, PPKTP and the like. Optical fiber can also be induced to have a non-linear response to optical radiation by fabricating microstructures in the fiber.

Phase-Matching refers to the technique used in a multiwave nonlinear optical process to enhance the distance over which the coherent transfer of energy between the waves is possible. For example, a three-wave process is said to be phase-matched when k₁+k₂=k₃, where kᵢ is the wave vector of the i^{th} wave participating in the process. In frequency doubling, e.g., the process is most efficient when the fundamental and the second harmonic phase velocities are matched. Typically the phase-matching condition is achieved by careful selection of the optical wavelength, polarization state, and propagation direction in the non-linear material.

Quasi Phase-Matched (QPM) Material: In a quasi-phase-matched material, the fundamental and higher harmonic radiation are phase-matched by periodically changing the sign of the material's non-linear coefficient. The period of the sign change (k_{QPM}) adds an additional term to the phase matching equation such that k_{QPM}+k₁+k₂=k₃. In a QPM material, the fundamental and higher harmonic can have identical polarizations, often improving efficiency. Quasi Phase-Matching may be accomplished by domain patterning a non-linear material. Examples of quasi-phase-matched materials include periodically-poled lithium tantalate (PPLT), periodically-poled lithium niobate (PPLN), periodically poled stoichiometric lithium tantalate (PPSLT), periodically poled potassium titanyl phosphate (PPKTP) or periodically poled microstructured glass fiber.

Ultraviolet (UV) Radiation refers to electromagnetic radiation characterized by a vacuum wavelength shorter than that of the visible region, but longer than that of soft X-rays. Ultraviolet radiation may be subdivided into the following wavelength ranges: near UV, from about 380 nm to about 200 nm; far or vacuum UV (FUV or VUV), from about 200 nm to about 10 nm; and extreme UV (EUV or XUV), from about 1 nm to about 31 nm. V number (V#) refers to a dimensionless parameter that quantifies the effective size of an optical waveguide.

Vacuum Wavelength The wavelength of electromagnetic radiation is generally a function of the medium in which the wave travels. The vacuum wavelength is the wavelength electromagnetic radiation of a given frequency would have if the radiation were propagating through a vacuum and is given by the speed of light in vacuum divided by the frequency.

Wavelength generally refers to the distance for one cycle of radiation. Unless otherwise specified, the term wavelength of radiation refers to the vacuum wavelength.

Introduction

Embodiments of the present invention overcome the disadvantages associated with the prior art by providing a waveguide that only supports one mode at all wavelengths of interest. It is noted at the outset that this requirement may appear to be self contradictory. A waveguide that is single-moded at a long wavelength is generally multi-moded at significantly shorter wavelengths. Hence, a waveguide used for second order nonlinear optics will generally be multi-moded for at least one of the wavelengths of interest. This is a well-known problem in the field of waveguide nonlinear optics. Typical solutions include extremely careful launch conditions (typically involving an adiabatic taper from a true single-mode waveguide), or restriction to nonlinear interactions where the input wavelengths are long enough for the waveguide to be single-mode without cutting-off a longer wavelength of interest (i.e. SHG or near-degenerate SFG).

A convenient measure used to determine the efficiency of waveguide nonlinear optical interaction is the “effective area” of the interaction, which in the context of nonlinear optical processes may be defined as the area of a uniform-intensity plane wave that would exhibit the same efficiency for the interaction of interest. Effective area may be calculated from an overlap integral between two or more interacting modes, and can be thought of as being dominated by two factors: (1) the actual size of the waveguide and/or modes, and (2) their degree of similarity. Smaller modes tend to produce smaller effective areas (and thus higher efficiencies). Modes that are more similar to one another also tend to produce smaller effective areas (and thus higher efficiencies). Symmetric waveguides produce symmetric modes that tend to be more wavelength-independent in shape, size, and centroid location (all of which factor into the effective area). Hence, it is desirable for waveguides to be symmetric, or nearly symmetric.

In addition, high V# waveguides typically exhibit greater degrees of wavelength independence for the fundamental modes. Hence, a symmetric high V# waveguide with a small mode (accomplished with a high index step) is most desirable for highly efficient (small effective area) NLO interactions. Prior-art low-V# channel waveguides have two problems: (1) Their mode size is highly wavelength dependent, giving poor effective areas for interactions, even when small modes (and hence high intensities) at one wavelength are guided. Also, the degree of asymmetry of the mode is wavelength dependent, further degrading effective areas. (2) These waveguides result in multi-moded behavior at short wavelengths, even when they are weakly guiding at long wavelengths.

Most optical materials exhibit some limitation on their optical intensity handling capability. Hence, for high power operation (particularly at short wavelengths), it is desirable to have a large mode size. While this is compatible with the desire for high V#, it is incompatible with the desire for small effective areas via small modes. In addition, for many waveguide fabrication technologies, it is easier to fabricate a large structure than a small structure. The requirements of phasematching or quasi-phasematching tend to be easier to achieve for high V# waveguide designs because of the reduced relative effect of waveguide dispersion. To the extent that waveguide dispersion is unimportant, the exact dimensions of the waveguide are unimportant. For these various reasons, a large V# is usually preferred in waveguide devices according to embodiments of the invention.

As may be seen from the discussion above, fabrication and materials factors favor large waveguides, while efficiency factors favor small waveguides. Clearly, there is a compromise size that balances the efficiency, materials, and fabrication factors. Given that compromise size, it is desirable to get the best efficiency possible from that waveguide size—accomplished by designing for high V# and near-symmetry, while maintaining single-modedness. This combination of requirements is generally considered to be impossible to satisfy. However, as will be explained below, embodiments of the present invention may achieve single-moded operation over a wide range of wavelengths while maintaining a near-symmetric design with a high V#.

To facilitate understanding of embodiments of the invention it is useful to have working understanding of “modes” and “modedness” and guiding of modes. As the term is generally understood with respect to waveguides, a “mode” may be regarded as a field or intensity distribution for light that propagates without change of shape or loss. Field distributions for light that propagate without change of shape, but with loss, are sometimes called “quasi-modes” because they radiate power as they propagate due to intrinsic features of the waveguide structure. A mode maintains its field distribution over the entire length of propagation, with only a phase shift. Quasi-modes have infinite tails (in some analyses, oscillating tails) of constant field, thereby giving radiation of power out of the central lobe(s) of the mode. This radiation loss is different from loss due to scattering because it occurs without any axial perturbations, and it is not due to absorption.

Practically speaking, a mode (or quasi-mode) is said to be “guided” if it propagates with low enough loss through the waveguide device for its entire length. Since modes can interfere with each other with fields, rather than with powers, even a few percent of light being present in a mode can be significant. Thus, a practical definition of “guided” is a loss of 10-20 dB of loss (or less) for the device length of interest, typically on the order of 1 cm. It is noted, however, that some photonics devices can tolerate higher loss in some cases. For some applications, waveguide nonlinear optical devices of 1 mm length may be useful, while for other applications, device lengths of several cm are more desirable. Generally, the fundamental mode should have a much lower loss, ideally zero, but more realistically 0.1-0.5 dB for the device length. Hence, another reasonable way to define a mode as “guided” is in relation to the loss of the desired fundamental mode.

There are three basic ways in which light can get into undesired (high-order) transverse modes: (1) At the point of launching, (2) via nonlinear optical generation—intentional or otherwise, and (3) via scattering between modes caused by defects or other features. Hence, it is sometimes necessary to eliminate light in undesired high-order modes in a distance shorter than the device length. Thus, for example, a 1-cm device may require adequate high-order mode loss in a 1-mm length. Therefore, according to embodiments of the invention, a waveguide may be provided with only one mode or quasi-mode with very low loss, and where all other quasi-modes have sufficiently high loss that for most of the device length, nearly all of the power present is in the fundamental mode.

To understand the relation between waveguide modedness and V# it is useful to consider, first, a waveguide with confinement in only one dimension, typically referred to as a “slab” waveguide. This geometry is easy to analyze because its mode structure is described by a single differential equation. Any textbook about optical waveguides begins with this case—for example: D. Marcuse “Theory of Dielectric Optical Waveguides” or Pochi Yeh “Optical Waves in Layered Media” (see chapter 11.) A slab waveguide is generally a stack of layers of material containing a planar core layer of refractive index n_{core} and a planar cladding layer of refractive index n_{clad}. For the slab waveguide, the width and length of the core layer are much greater than the thickness of the core layer. The V# of a symmetric slab waveguide is defined as

$$\frac{π t}{λ} \sqrt{( {n}_{core}^{2} - {n}_{clad}^{2} )} ,$$

where t is the thickness of core layer. For a V# between 0 and π/2, there is only one transverse electric (TE-polarized) mode (i.e. the fundamental mode). For V# from π/2 to π, there are two TE-polarized modes, and so on. The cutoff V# corresponding to transverse magnetic (TM-polarized) modes is typically similar to that of TE-polarized modes. In the case of asymmetric slab waveguides having two or more cladding layers of different refractive indices, the n_{clad} in the definition of V# refers to the larger of the two cladding refractive indices. In the case of asymmetric slab waveguides, there is no guided mode for a sufficiently small V#, and the cutoff conditions for all high-order modes can shift around a small amount, relative to the symmetric case. However, even highly asymmetric slab waveguides become multi-moded for V# near 2. Generally, a slab waveguide (regardless of degree of asymmetry) will support a number of modes of each polarization orientation that is roughly proportional to (2/π)×V#. Using this rule of thumb, a slab waveguide having a 5-micron thick core of Lithium Tantalate (n˜2.15) and a SiO₂ (n˜1.45) cladding has a V# of 27 for a 920-nm wavelength λ supports approximately 17 modes. As will be described below, a numerical simulation of this case for scalar fields produced 18 guided modes—in good agreement with the rule of thumb.

The above concepts may be applied to analysis of the relation between waveguide modedness and V# in channel waveguides. A channel waveguide may be regarded as one for which the width of the core layer is comparable to the thickness t. This geometry is more difficult to analyze than the slab waveguide. Channel waveguides may be analyzed approximately and/or numerically. However, the concept of V# is useful for analyzing modedness of channel waveguides. Because there is guiding in two transverse dimensions, there is an opportunity for multiple modes to be supported in each dimension. Often, waveguide modes are approximated as separable. Then, horizontal “modedness” and vertical “modedness” can be analyzed separately. As an example, a 1.0 micron×1.1 micron waveguide having a Lithium Tantalate, core surrounded by a SiO₂ cladding may be simulated using a finite element method and found to support transverse 5 modes of each polarization. The dimensions in this example were chosen to break the degeneracy of horizontal and vertical modes, thereby eliminating some numerical artifacts.

Using a similar analysis, a 2.0×2.2 micron waveguide with the same refractive indices may be shown to support more than twenty transverse modes of each polarization. In this regime, the numerical methods used for the analysis become somewhat complicated. Nonetheless, the key point is that even rather small dimensions can support very large numbers of modes when the refractive index steps are large. Using the same definition of V# as was used for the slab waveguide, above, 1.0×1.1-micron and 2.0×2.2-micron channel waveguides would have V#s of ˜5 and ˜10, respectively. Extrapolating these results would predict that a 5 um×5 um channel waveguide a Lithium Tantalate, core surrounded by a SiO₂ cladding would support well over a hundred transverse modes, and would thus be highly undesirable for use for nonlinear optics. Hence, a practitioner in the art of waveguide nonlinear optics would expect that a high-V# waveguide of any shape would support many transverse modes.

A conceptually simple (but difficult to analyze) waveguide structure with confinement in two dimensions is known as the Ridge waveguide. The ridge waveguide has a core layer with slab-like regions of thickness t and a channel-like localized thicker region of core layer material of thickness h and width w running lengthwise along the core layer. This structure is widely used for semiconductor optical devices (though only with a low V#) because it is simple to implement at a wafer scale in eptaxially-grown material systems. Ridge waveguides have strong confinement in one dimension (usually vertical, or perpendicular to the plane of the wafer on which it is typically fabricated) that is produced by a non-zero refractive index step between a core material/layer and one or more cladding materials. Lateral guiding is then produced with the localized thicker core region, called the ridge.

Modes of ridge waveguides can extend far from the ridge, but decay with increasing distance from the ridge. Typically, ridges are asymmetric, in the sense that one core/cladding interface is planar, while the ridge protrudes perpendicularly with respect to the core region in only one direction. Specifically, for an asymmetric ridge, the ridge projects beyond the surface of the slab-like regions by a height h-t, sometimes referred to as the etch depth. A ridge waveguide could be made symmetric, e.g., by having a ridge that projects beyond both major surfaces of the slab-like region. This may have a slightly beneficial impact on modal effective area, but (as will be described below) a negative impact on high-order mode control.

A simple way to analyze 3-dimensional structures (waveguides with confinement in two dimensions), such as ridge waveguides, is called the “effective index approximation”, and is well known in the art. This method is approximate in nature, but is considered accurate for waveguide structures that have strong confinement in one dimension and weak confinement in an orthogonal dimension. The method is best at calculating the effective index of a mode, and as such, can be used to determine which modes could exist in the absence of other mode-selection mechanisms. Hence, although the following analysis is approximate, it demonstrates some of the concepts that are useful for understanding of embodiments of the present invention.

Consider symmetric step-index waveguides with the scalar wave equation. (Actual waveguide modes and indices will differ slightly due to the different boundary conditions resulting from the appropriate vector wave equation, but vector effects are not required to explain why embodiments of the present invention can produce single-mode waveguides. Therefore, for simplicity, the scalar wave equation may be used. Further consider a single wavelength of 920 nm and a single material pair. Assume a core index of 2.15 (an approximate value for LiTaO₃) and a cladding (upper and lower) index of 1.45 (an approximate value for SiO₂). Hence, an index step of 0.70 is assumed—an index step which is very large by the standards of conventional single-moded waveguide design. The interesting (and only remaining) parameter to study is the core thickness. For a nominal thickness of 5 microns, one finds that 18 distinct modes are supported by the waveguide. The lowest-order (fundamental) mode has an effective refractive index of 2.1482, which is very close to the bulk index of the core—consistent with the waveguide being highly confining in this dimension. The highest-order guided mode (with 17 zero-crossings of optical electric field within the core) has an effective refractive index of 1.4672, which is very close to the bulk index of the cladding—consistent with the waveguide being almost cut-off for this mode in this dimension.

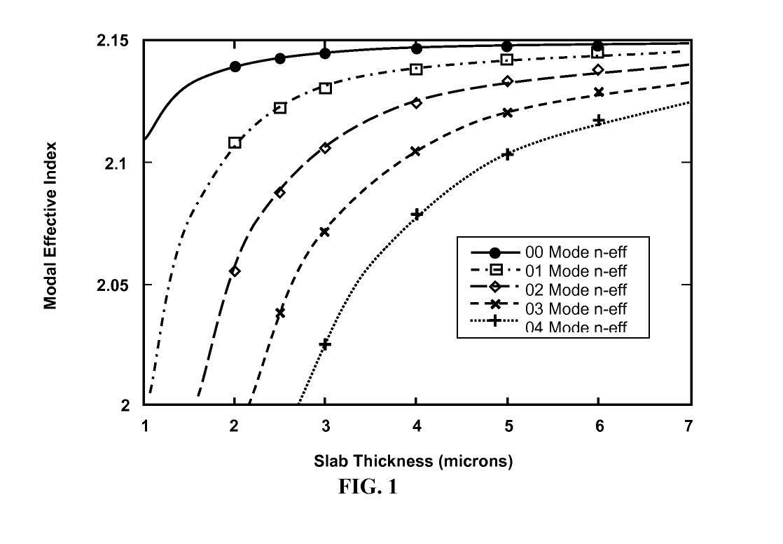

FIG. 1 shows computed values the effective refractive indices for the first 5 guided modes as a function of core thickness in the above example. Note that for slab thickness t larger than about 2 microns, the fundamental mode effective refractive index is not very sensitive to slab thickness, which implies that the phasematching/quasi-phasematching condition is not very sensitive to exact waveguide dimensions (as compared to how sensitive it would be for thinner slabs). Also note that the higher-order modes exhibit greater sensitivity to the slab thickness, a property that is important for understanding the behavior of high order modes in the complete 3D structure (with confinement in 2 dimensions).

Under the effective index approximation method, a second slab waveguide may then be analyzed, but using the effective indices previously calculated for the two core thicknesses of interest. To analyze a ridge waveguide with a 5-um thick by 4-um wide ridge on a 3-um thick slab, one first calculates the effective index for a 3-um slab and a 5-um slab, then constructs a hypothetical 4-μm thick (actually, “wide”) slab with a core refractive index corresponding to the previously calculated 5-μm slab, a cladding refractive index corresponding to the previously calculated 3 um slab, and a 4-μm thick core. Using the fundamental (00) modes from above, this implies a core index of 2.148168 and a cladding index of 2.145142. Notice that this implies a very small index step of ˜0.003—giving only weak confinement in the lateral dimension. This weak confinement keeps the “horizontal V#” low, and hence keeps the waveguide single-moded in the lateral dimension.

Due to the lateral symmetry assumed in the structure, the fundamental mode never “cuts-off”. The lateral mode size can grow large for sufficiently small effective index steps (e.g., for ridge heights very similar to the slab height). If the horizontal V# is allowed to exceed roughly π/2, then multiple lateral modes may be supported. If this is not desirable, a high horizontal V# may be avoided by keeping the ridge width narrow enough, or by keeping the ridge etch depth shallow enough (i.e. keeping the ridge height and slab height similar), or by preventing high-order vertical modes from existing. The high-order vertical modes exhibit larger sensitivity to slab thickness in terms of their effective index, and thus exhibit larger lateral V# values for the same waveguide dimensions.

Additional discussion of the behavior of high-order modes in ridge waveguides is useful to appreciate embodiments of the present invention. A simple way to describe a transverse mode of a ridge structure is based on the number of zero-crossings in each region and in each dimension. (This is analogous to the free-space Hermite-Gaussian transverse electromagnetic (TEM) modes named TEM00, TEM01, TEM10, TEM20, etc . . . ) The two regions of interest are (1) under the ridge, and (2) in the slab not under the ridge. The slab region typically only supports vertical zero-crossings (as opposed to lateral zero-crossings) due to the lack of lateral confinement in this region. Nonetheless, a large number of zero-crossings can, in principle, exist in the slab region—for example 0-17 crossings for a 5-um thick slab with an index of 2.15 and surrounded by a cladding index of 1.45 for a wavelength of 920 nm. These corresponding to the 18 modes mentioned above for this structure. The ridge region can, in principle, support zero-crossings in both the vertical and lateral dimensions. However, because of the relatively small effective index steps that are of interest, there is no reason to make a ridge wide enough to support multiple lateral modes. It is relatively easy to avoid multiple lateral modes by keeping a sufficiently small “effective index” V# for the effective lateral guide formed by the ridge.

Also, generally, if multiple lateral modes were guided, then there would also be multiple vertical modes guided in the same structure. Hence, for simplicity, the possibility of multiple lateral modes may be ignored. Therefore, all interesting transverse modes of a ridge structure can be described by two integers: the number of zero crossings under the ridge and the number of zero crossings in the slab not under the ridge. In embodiments of the present invention the materials and dimensions of a ridge waveguide may be chosen to assure that only the 0+0 transverse mode exists for the wavelength(s) of interest—hence that the waveguide is single-moded.

There are two interesting categories of high-order modes that will be discussed separately. “Simple” high-order modes have the same number of zero-crossings under the ridge as in the slab, while “compound” high-order modes have more zero-crossings under the ridge than in the slab. Examples of simple modes are 1+1, 2+2, etc . . . Examples of compound modes are 2+1, 1+0, 2+0, 3+2, etc . . . It is generally not possible to have fewer zero-crossings under the ridge than in the slab for a guided mode. Even if it were possible, it would be undesirable in many applications for such modes to be allowed by a waveguide structure.

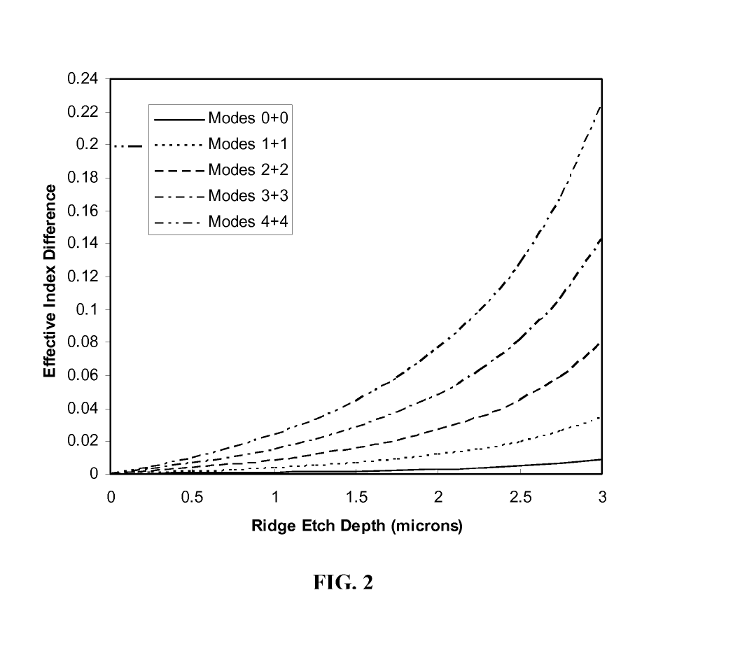

The preceding analysis does not imply anything definite about the existence of vertical high-order modes in a ridge waveguide. It merely describes the effective indices of these high-order modes within each of the two regions of interest (the slab and the ridge) if they exist. There are additional constraints on existence of modes, in addition to the constraints of the one-dimensional vertical confinement. One such constraint relates to the lateral V#, which must be positive—i.e. the effective index under the ridge must exceed the effective index in the slab region. The graph in FIG. 2 plots the effective index difference of the simple modes as a function of ridge etch depth. As shown in the FIG. 2, simple modes always have positive effective index steps (and thus positive lateral V#)—and hence may be guided. As suggested in previous sections, the higher-order modes have increased effective index steps, and thus an increased degree of confinement.

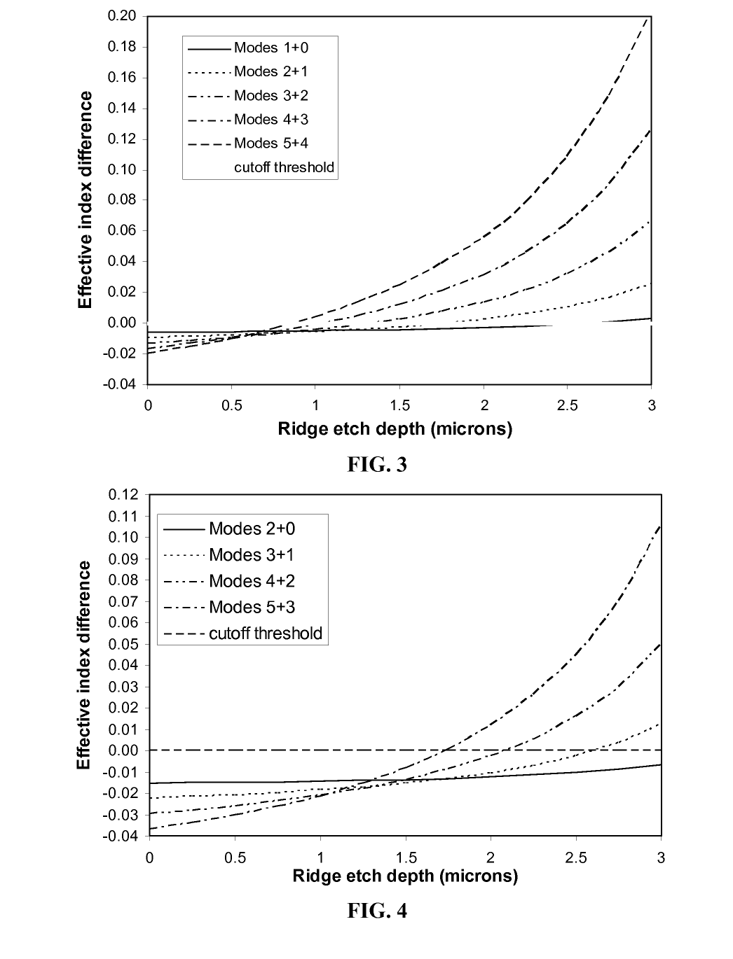

The graph in FIG. 3 shows the effective index difference of compound modes, in which the ridge supports one more zero-crossing than the slab region, as a function of ridge etch depth. For the graphs in FIG. 2 and FIG. 3 a LiTaO₃ core and SiO₂ cladding structure with a 5-micron thick ridge is assumed. Similar results may be expected for proportional etch depths with other ridge thicknesses. Although ridge width or sidewall angle does not enter into this simplified effective-index analysis, these parameters may be important. The most striking feature of FIG. 3 is that for ridge depths shallower than about 1-2 microns (depending on which mode pair is considered), the compound modes considered all have negative effective index steps (and thus V#)—and thus cannot be guided, regardless of other factors. In this case, the modes are typically referred to as “cut-off” and the waveguide is referred to as an “anti-guide” for this mode.

As may be seen from FIG. 3, it is desirable for the ridge etch depth to be shallow enough that some or all compound modes are excluded from existence due to this mechanism. The exact threshold etch depth may differ slightly from the above value due to the influence of many other factors, such as: ridge width, vector nature or actual mode fields, sidewall angle of ridge, approximate nature of the effective index approximation, etc. For example, the threshold ridge etch depths implied by the above figure are valid for very wide ridges, whereas for narrower ridges one would expect that even deeper etch depths may be required to allow for guiding of these modes. Such factors can be analyzed numerically.

FIG. 4 is a graph showing the effective index of compound modes, in which the ridge supports two more zero-crossings than the slab region, as a function of the ridge etch depth. These compound modes are cut-off (anti-guiding) for ridge etch depths up to about 2 microns. Hence, this family of compound modes is easy to avoid by proper choice of waveguide dimensions—essentially by limiting the ridge etch depth to a small-to-modest fraction of the total slab thickness. Other families of compound high-order modes can be envisioned, by extension, but with an even wider anti-guiding range of ridge etch depths.

As may be seen from FIGS. 3, 4 and 5, compound modes generally only exist for relatively deep etch depths, regardless of the values of other parameters. It is noted that the preceding analysis does not rely on the wavelength of light, or on the exact value of the vertical V#, but only on the requirement that the vertical V# is sufficiently large. Hence, the above concepts are important for achieving wide-wavelength-range modedness control. It is further noted that there are additional constraints on the existence of modes, as described below.

Guided modes of any waveguide structure share some general characteristics—in particular they lack abrupt changes in dimensions and fields. A simple reason why this must be so is that rapid changes in mode features imply wide-angle light rays, which may not be totally-internally-reflected within the waveguide structure. However, a more stringent requirement for smoothness can be understood within the context of the effective index approximation. When solving the 1-dimensional wave equation, one finds that the rate of change of field (and how quickly it can oscillate from positive to negative amplitude) depends on the difference between the mode's propagation constant and that of the core region. Under the effective index approximation, the core region (which is actually the ridge region) has a propagation constant of the appropriate mode calculated for the 1-dimensional solution for the ridge.

Since a guided mode must have a propagation constant between the values for the effective core and the effective cladding, and since it has been shown above that low effective index steps (low lateral V#s) are typical of ridge waveguides in high vertical V# layers, one may deduce that fields can only change slowly with respect to lateral position. The lower the lateral V#, the slower the field can change. The implications of this observation may be best understood by considering a few simple cases.

At one extreme, if the ridge height is sufficiently similar to the slab height (i.e. the ridge etch depth is small), then the two vertical modes that must connect are very similar, and thus a very short transition region is required to assure smoothness and/or continuity, even for low lateral V#. If the heights differ by a large amount (i.e. the ridge etch depth is a large fraction of the total waveguide height), then the effective-index step is large and the fields can adjust significantly over a relatively short distance—enabling a smooth-enough transition between two apparently different vertical modes. If the height difference is between these extremes, then the mode shape may or may not be able to adjust in a short enough distance to smoothly connect the regions with significantly different heights. Increasing the width of the ridge provides a larger distance over which the mode shape can adjust, and thus allows for a more dramatic change in mode size/height between the ridge and the slab. The V# is a parameter that includes both the waveguide width and the index step, and hence it is a measure of how much a mode shape can change between the ridge and the slab. A quantitative metric of the degree of mismatch that must be overcome is, thus, important. A commonly used metric for modal similarity is the “overlap integral” between the optical fields of the two modes of interest.

While it is true that all guided modes of the same structure are strictly orthogonal (have zero overlap integral—implying zero similarity), the two (vertical) modes of interest in this example are not modes of the same (vertical) structure. Rather, one is a 1-dimensional vertical mode under the ridge, and the other is a 1-dimensional vertical mode not under the ridge (i.e. in the slab region.) These two regions have different dimensions (otherwise there would be no ridge), and they are not centered on each other (i.e. most ridge structures are weakly vertically asymmetric.) These differences break the orthogonality between the two sets of modes, and enable both large and small overlap integrals, depending on the pair of modes considered. It is noted that the weak asymmetry inherent in the basic ridge geometry is highly advantageous, but not strictly necessary to benefit from the effects described above.

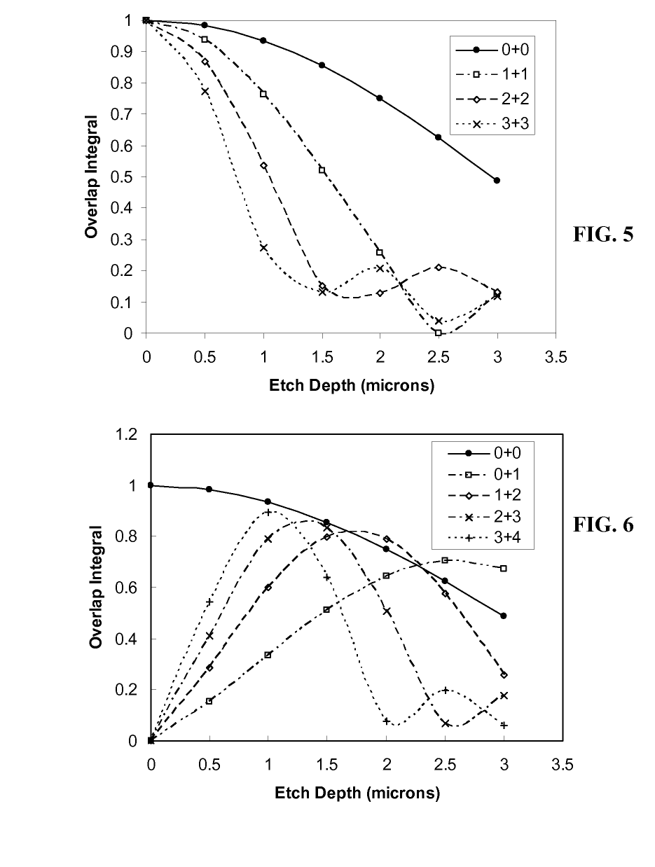

FIG. 5 is a graph showing the overlap integrals between four pairs of simple vertical modes as a function of the ridge etch depth. The four modes are all “simple” (as opposed to “compound”) modes, as defined above. As before, a 5 micron thick ridge section is assumed, as are the refractive indices of 2.15 and 1.45. The scalar wave equation may be used to solve for the modes. Finally, a wavelength of 920 nm was assumed. Selecting a wavelength is required to find modes, but is only significant for the highest-order modes in each series. While 18 mode solutions exist under the 5 micron ridge, only several of the lowest-order modes give interesting results. For simplicity, the remainder will be ignored for this analysis. Note that in the limit of zero etch depth, all mode pairs considered have a perfect (unity) overlap integral because they are the same mode. As the ridge etch depth is increased, all of the overlap integrals are reduced. However, for finite etch depths, the higher order modes suffer a greater mismatch (i.e. have lower overlap integrals) than the fundamental mode. Hence, high order modes are more difficult to match via smooth transitions between the ridge and the slab regions. The higher-order the mode, the more difficult the smooth transition becomes. Also note that for sufficiently deep etches, the overlap integrals for all high-order modes tend to oscillate between 0-0.2, whereas the overlap integral for the fundamental mode pair is still reasonably high. This indicates a strong selection mechanism in favor of the fundamental mode. However, from the discussion above, high-order mode pairs exhibit a greater lateral effective index step due to the larger effective index steps. Hence, when the etch depth is shallow, the “simple” high-order modes can only be eliminated for sufficiently narrow ridge widths that result in low-enough lateral V#, despite the high lateral effective index step. It may also be possible to eliminate “simple” high-order modes using a deep etch depth, by taking advantage of the poor overlap integral under such conditions.

FIG. 6 is a graph showing the overlap integrals between six pairs of vertical modes as a function of the ridge etch depth. The first mode is a the fundamental (0+0 “simple”) mode duplicated from the FIG. 5, while the remaining five modes are “compound” with one more zero crossing under the ridge than in the slab region. The same assumptions regarding core and cladding material, slab thickness and ridge thickness were made as in FIG. 5. Unlike before, in the limit of zero etch depth, all compound mode pairs considered have a zero overlap integral, as required by orthogonality.

As the etch depth is increased, all of the compound-mode overlap integrals are increased, as the 0+0 mode overlap integral is decreased. For modest etch depths (>0.8 micron), the compound modes, in succession, achieve comparable overlap integrals to that of the fundamental mode. In fact, for very deep etches (about 2.5 microns, or about 50% of the total ridge thickness), the lowest-order compound modes achieve overlap integrals higher than that for the (desired) fundamental mode. These “peaks” in the overlap integrals correspond roughly to the condition where the “corners” of the etched ridge lie at the null (i.e. zero-crossing) of the mode pattern that may be guided. With respect to this mechanism (mode similarity making it easy for a mode to smoothly transform between the ridge and the slab), it is undesirable to operate with designs that place these compound-mode overlap integrals near that of the fundamental mode (which is known to be guided for all of these conditions.) In the case of deeper etches, the overlap integrals for these compound modes degrade to very low values, and remain poor.

From the above discussion of FIG. 6, it would appear that, for any modest etch depth, there exists at least one compound mode with a high overlap integral. However, high overlap integral is not the only requirement that must be satisfied for the mode to exist. Specifically, from the discussion of FIG. 3 and FIG. 4 it may be seen that each of the compound modes has a negative effective index step (and hence a negative lateral V#) for etch depths up to a certain value. By comparing FIG. 6 with FIG. 3 and FIG. 4, it may be seen that for all of the compound modes in FIG. 6, most of the region of high overlap integral is forbidden by a negative effective index. Hence, only narrow regions of etch depths (on the deeper-than optimum for overlap integral side of the peak) offer the potential for these compound modes to exist. These narrow regions represent a compromise between sub-optimal overlap and only slightly-positive lateral effective index step. Hence, these compound high-order modes may be eliminated if the ridge width is sufficiently narrow that the lateral V# is insufficient to enable the mode shape to smoothly adjust.

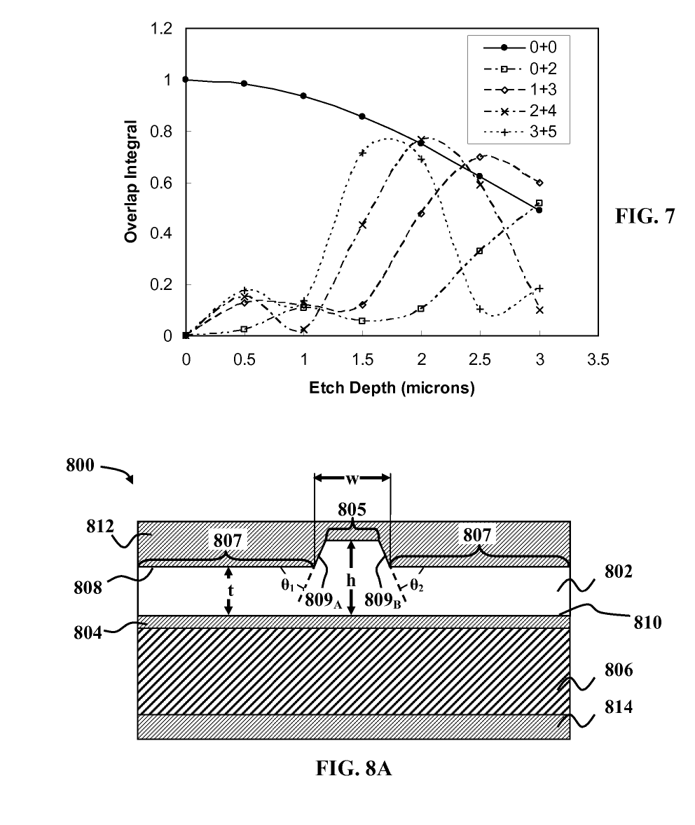

FIG. 7 is a graph showing the overlap integrals between five pairs of vertical modes as a function of the ridge etch depth. The first mode is the fundamental (0+0 “simple”) mode duplicated from FIG. 5 and FIG. 6, while the remaining four modes are “compound” with two more zero crossings under the ridge than in the slab region. The same other assumptions were made as before. The same observations can be made, and the same conclusions can be drawn.

Hence, the effective index approximation analysis implies that all types of high-order modes may be eliminated for sufficiently narrow ridge widths by taking advantage of the interaction between the effects of poor modal overlap between mode solutions under the ridge and in the slab, the requirement for gradual change in mode shape, and the negative or small positive lateral effective index step that results from imposing a ridge geometry onto a high V# slab waveguide.

It is noted that this analysis does not rely on the wavelength of light, or on the exact value of the vertical V#, but only on the requirement that the vertical V# is large. Hence, the above concepts are important for achieving wide-wavelength-range modedness control.

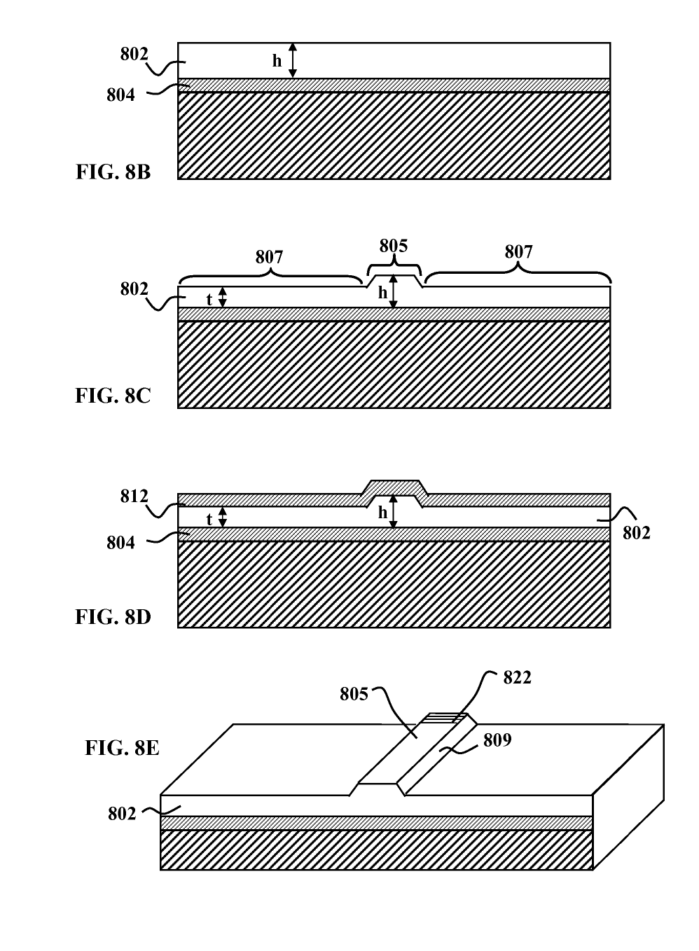

Based on the above analysis, a waveguide device may be designed for single-moded operation over a wide range of wavelengths while maintaining a near-symmetric design with a high V#. FIG. 8A depicts a cross-sectional layer structure of an optical waveguide device 800 of an embodiment of the present invention. The optical waveguide device 800 includes a substrate (or lower cladding) 806 made of a first material, a core layer 802 made of a ferroelectric second material characterized by an index of refraction n_{core}. A buffer layer 804 may be disposed between the substrate 806 and the core layer 802. The buffer layer 804 may be made of a material characterized by an index of refraction n_{buff} that is less than n_{core} if n_{subst} is greater than or equal to n_{core}.

The substrate material 806 may be an optically transmissive material having a refractive index n_{subst} that is greater than or equal to n_{core}. Alternatively, the substrate 806 may have n_{subst}<n_{core}. In such a case, the substrate 806 may serve as a cladding for the waveguide device 800.

The core layer 802 has a first surface 808 with a ridge structure 805 and a second surface 810. The ridge structure 805 is characterized by a cross-sectional width w and a thickness h relative to the second surface 810. The ridge structure 805 may include sidewalls 809_{A}, 809_{B} oriented at angles θ₁, θ₂ relative to the first surface 808 of the core layer 802. It is not necessary that the sidewall angles of both sides of the ridge structure 805 be identical. Some etch processes may generate a ridge structure 805 having asymmetrical sidewall angles, without detrimentally affecting performance of the resulting optical waveguide device 800. In embodiments of the present invention, the material of the substrate 806, n_{core}, h, t and w and (optionally) angles θ₁, θ₂ may be selected such that the optical waveguide device 800 is characterized by low loss for a fundamental mode and high loss for higher order modes, wherein the high loss is sufficiently high that the waveguide is effectively single-moded, as described above.

The ridge structure 805 may be characterized by a length between about 1 mm and about 50 mm, preferably between about 5 mm and about 30 mm in a direction perpendicular to the cross-section illustrated. The optical waveguide device 800 may include an optional upper cladding layer 812 to protect a top surface of the core layer 802 and keep it clean. By way of example, the upper cladding layer 812 may be a layer of SiO₂. The optical waveguide device 800 may further include a layer 814 coating a bottom surface of the substrate 806. The layer 814 may be made of a material characterized by an index of refraction that is less than n_{subst}. By way of example, the layer 814 may be a relatively, low index material, e.g., SiO₂, e.g., about 2 microns thick. Such a coating can provide a total internal reflection surface to keep scattered light within the substrate 806 and away from an adhesive on this surface.

The core layer 802 further includes one or more slab portions 807 adjacent the ridge structure. The slab portions are characterized by a thickness t between the first surface 808 and the second surface 810 of the core layer 802, with t being less than h. In contrast to certain prior art waveguide devices, the waveguide device 800 allows for single modedness over a wide wavelength range even without trenches or raised slab portions on either side of the ridge structure 805. The slab portions 807 may therefore be of substantially uniform thickness in regions extending from the sidewalls 809 to edges of the core layer 802.

By way of example, the buffer layer material 804 may be silicon oxide (e.g., SiO₂) or aluminum oxide (alumina). It is noted that alumina has a broad transparency window compared to SiO₂. Preferably, the buffer layer 804 is sufficiently thick that light guided in the core 802 is not significantly coupled to the substrate 806. By way of example, for a waveguide length of about 1 cm, light guided by the core is not significantly coupled to the substrate if there is less than about 1 dB/cm of such coupling. The thickness of the buffer layer 804 may generally be comparable to the largest wavelength guided by the core 802.

The substrate 806 may be made relatively thin to reduce thermal impedance between the core layer 802 and a heat source or heat sink that is at a well-controlled temperature. The substrate 806 may be less than about 500 microns thick, typically less than about 250 microns thick, preferably less than about 100 microns thick. According to a first embodiment of the invention, the material of the substrate 806 may be either optically non-transparent or have an index of refraction, n_{subst} that is greater than or equal to n_{core}. The substrate 806 may be made of a thermally conductive material having a coefficient of thermal expansion that matches a thermal expansion coefficient of the material of the core layer 802. By way of example, the substrate 806 may be a congruent lithium tantalate (CLT) material and the core layer 802 may be made of quasi-phasematched stoichiometric lithium tantalate (QLT). Optical grade CLT is commercially available, e.g., from Yamaju Ceramics Co. Ltd of Aichi, Japan or SAES getters of Milan, Italy. CLT often comes pre-polished from the vendor.

More generally, the material of the core layer 802 may be a nonlinear optical material or ferroelectric material. By way of example, the material of the core layer 802 may be a lithium tantalate material, such as stoichiometric lithium tantalate (SLT). It is noted that the term stoichiometric, as used herein, generally refers to a material having integer or nearly integer proportions of its constituent elements. In the case of perfectly stoichiometric lithium tantalate (LiTaO₃), the ratio of Li:Ta:O would be 1:1:3. In certain embodiments of the invention, the ratios of Li:Ta:O may vary from being perfectly stoichiometric to some degree. For example, desirable results may be obtained, even at high optical powers (greater than about 0.5 W) in the device 800 if the Li:Ta:O ratio in the SLT is 1:1:3 to within about 99.99% to about 100:01%. In such a case, the material is referred to herein as being substantially stoichiometric. At high optical power, even a relatively small variation from substantially stoichiometric may have undesirable consequences. For example for a Li:Ta:O ratio in the SLT that is only good to within about 99% to 101% (referred to herein as being nearly stoichiometric), visible induced infrared absorption may occur at high optical power, resulting in long term material degradation, loss in device performance or destruction of the device. However, for lower power applications, nearly stoichiometric lithium tantalate may be acceptable. As such, the term stoichiometric lithium tantalate (SLT) is understood to include herein both nearly stoichiometric lithium tantalate and substantially stoichiometric lithium tantalate as well as perfectly stoichiometric lithium tantalate.

The material of the core layer 802 may be doped with magnesium oxide, zinc oxide or yttrium oxide. For example, lithium tantalate may be doped with magnesium oxide to a concentration of between about 5% and about 7%. In the case of SLT it is also desirable for the SLT to have an iron content of less than one part per million (ppm).

Where SLT is used in the core layer 802, many compatible materials for use in the substrate 806 (e.g., congruent lithium tantalate (CLT), congruent lithium niobate (CLN), magnesium oxide doped lithium niobate (MgO:LN) or magnesium oxide doped lithium tantalate (MgO:LT) have a higher refractive index than SLT. A waveguide device based on a core layer 802 of SLT and a substrate 806 of CLT may have a core with a high optical power handling capability and a strong substrate that is less likely to break during processing and/or handling.

Alternatively, the core layer material 802 may be a quasi phase-matched lithium tantalate material. Such quasi phase-matching may be accomplished, e.g., by patterning domains on the lithium tantalate material of the core layer material 802. Examples of domain patterning of ferroelectric materials such as lithium tantalate are described, e.g., in U.S. Pat. Nos. 6,542,285 and 6,555,293, the entire disclosures of both of which are incorporated herein by reference. It is noted that periodic poling is a sub-category of domain patterning.

For certain nonlinear frequency-converting waveguide applications it may be desirable for the core layer material 802 to have a low radiation-induced absorption coefficient. By way of example, the radiation-induced absorption coefficient K refers to a coefficient relating heat H generated due to absorption of radiation at one or more wavelengths induced by the presence of absorption-inducing radiation of one or more other wavelengths. The absorption-inducing radiation may be internally generated, e.g., by a nonlinear process taking place in the waveguide device 800. Alternatively, the absorption-inducing radiation may be externally applied (e.g., via generation in some other portion of an overall apparatus of which the waveguide device is a component.) In general, the heat H is determined by: H=PᵢₙP_{fc}K, where Pᵢₙ is the power of the input radiation and P_{fc} is the power of frequency converted radiation produced from the nonlinear frequency conversion. By way of example, where infrared radiation of 1064-nm wavelength is converted to 532-nm (green) visible radiation by second harmonic generation, Pᵢₙ is the optical power of the infrared radiation and P_{fc} is the optical power of the green radiation. It is desirable for the radiation-induced absorption coefficient K to be less than about 0.1/Watt, preferably less than about 0.01/Watt and more preferably less than about 0.001/Watt. As an example, a 1 cm long waveguide that exhibits a radiation-induced absorption coefficient of 0.01/Watt would suffer from 1%/cm absorption of infrared radiation for each 1 Watt of visible radiation present.

In an alternative embodiment, the core layer 802 may be made of lithium tantalate and the substrate 806 may be made of an electrically conductive material, e.g., conductive lithium tantalate, copper, or a copper containing material. By way of example, the copper-containing material may be a pressed and sintered composite of copper and tungsten, CuₓW_{y}, where x ranges between about 0.1 and about 0.9 and y=1-x. The coefficient of thermal expansion (CTE) of lithium tantalate is very temperature dependent. The CTE of CuₓW_{y} may be adjusted for the temperature range of operation of the device by changing x. The use of a conductive material in the substrate 806 may reduce or prevent arcing during operation of the device 800. Arcing may alternatively be reduced by coating the buffer layer 804 and/or substrate 806 with a conductive film, such as indium tin oxide (ITO).

If a buffer layer 804 is disposed between the core layer 802 and substrate 806 it is often desirable that the buffer layer 804 accommodate thermal expansion of the other two layers. For example, if the core layer 802 is made of lithium tantalate, the buffer layer 804 may be made of silicon dioxide (SiO₂), which has a relatively low Young's modulus and can stretch adequately when in the form of a thin film. In addition, it is desirable to have strong bonding between core 802 and buffer layer 804 and between the buffer layer 804 and the substrate 806. The buffer layer 804 may be formed on a lower surface of the core layer 802, an upper surface of the substrate 806 or partly on both surfaces prior to bonding. In high power applications, e.g., greater than about 0.5 watts of optical power launched into the waveguide device 800, it is further desirable that the bonding does not utilize an adhesive having hydrocarbon-based material that could fail under exposure to high optical power. Bonding may be implemented, e.g., by direct bonding, e.g., as described in “Highly Efficient Second-Harmonic Generation in Direct-Bonded MgO:LiNbO₃ Pure Crystal Waveguide” by T. Sugita et al, Electronics Letters 14, Oct. 2004, Vol. 40, No. 21, which is incorporated herein by reference.

After bonding, the core layer material 802 may be thinned down to the desired ridge thickness h as shown in FIG. 8B. The core layer material may be thinned, e.g., using a series of polishing steps. Uniformity of the thickness h across the surface of the device 800 may be controlled by careful control of pressures and material removal rates during polishing. The uniformity of the thickness h may be monitored, e.g., by interferometry. After the core layer material 806 has been thinned to the desired ridge thickness h. The ridge 805 may be formed as shown in FIG. 8C. By way of example, the ridge structure 805 and slab portion 807 may be formed by masking selected portions of the first surface 808 of the core layer material 802 corresponding to the ridge structure and etching un-masked portions corresponding to the slab portion. In some embodiments, measured variations in the thickness h of the core material layer 802 remaining after thinning may be compensated by variations in the width w of the ridge 805 to maintain constant phase velocity or group velocity matching in the waveguide device 800. Specifically, the thickness h may be measured across the core layer 802 and the results may be fit to a curve before designing the mask used to form the ridge 805. Phase velocity generally depends more strongly on ridge thickness h than on ridge width w by a ratio of about 5:1. Corrections of the ridge width w on the order of 250 nm could be used to correct for thickness errors of about 50 nm and are within the current state of the art. After forming the ridge, the cladding layer 812 may be deposited or otherwise formed on an upper surface of the core layer 802 including the ridge 805, as shown in FIG. 8D.

In embodiments of the present invention, the substrate material, n_{core}, n_{buff}, h, t, w and θ may be selected such that the optical waveguide device 800 supports a single transverse mode and a portion of the waveguide device under the ridge structure has a lateral V number larger than about π/2, when approximated as a slab waveguide of thickness w. The width w, thickness h, and refractive indices n_{core}, n_{subst} may be also be selected such that a vertical V number for a slab waveguide of thickness w is greater than about π for a longest wavelength of interest.

In some embodiments, the substrate material, n_{core}, n_{buff}, h, t, w and 0 may be selected such that the optical waveguide device 800 acts as a waveguide that supports a single transverse mode over a wavelength range from a shortest wavelength of interest λₘᵢₙ to a longest wavelength of interest λₘₐₓ that is at least twice as large as λₘᵢₙ. In addition, h, t, w and θ may be chosen such that the waveguide device 800 provides a substantially constant mode height and mode width at wavelengths of interest. In particular, these dimensions may be chosen to maximize an overlap integral of the interacting wavelengths with the help of numerical modeling.

For nonlinear-optical waveguide applications, nonlinear optical effects are highly dependent on optical field intensity. Therefore, w, h and t may be chosen to provide a desired average electric field intensity in the waveguide device 800. By way of example, w, h and t may be chosen to provide an average optical field intensity between about 1 Megawatts/cm² and about 100 Megawatts/cm² for an input signal having a given optical power.

By way of example, the cross-sectional width w of the ridge structure may be less than or equal to t and is about 3 to 8 times wider than a wavelength for radiation launched into the waveguide device. The cross-sectional width w of the ridge structure is about 4 to 16 times wider than a shortest wavelength of interest to be guided by the waveguide device. The sidewall angles θ₁ and θ₂ are preferably between about 45° and about 90°. The thickness h may be greater than about 1 micron, preferably between about 2 microns and about 10 microns, e.g., between about 3 microns and about 5 microns. In some embodiments of the invention, thickness h of the ridge structure 805 may vary by less than about 1% along the core layer 802.

The waveguide device 800 may have material dispersion and waveguide dispersion that influences the quasi-phasematching. There is a certain uniformity requirement in the thickness h that is required to keep the waves constructively interfering. This may be important because the more uniform the waveguide, the longer it may be. Nonlinear conversion efficiency increases with length. Therefore, a more uniform waveguide may be made longer and more efficient. In waveguides characterized by such high V#, the mode is contained within the core layer 802 and the percentage of the mode that overlaps with the cladding (e.g., substrate 806 or buffer layer 804) is substantially less than found in low-V# structures. Therefore, a high V# waveguide would be much more tolerant than a low V# waveguide to nonuniformity in dimensions. With higher V#, the waveguide device 800 becomes increasingly less sensitive to dimension errors.

The thickness t of the slab portion may be selected based on the formula

$$t > \frac{λ}{\sqrt{{n}_{core}^{2} - {n}_{buff}^{2}}} ,$$

where λ is a shortest wavelength of interest for radiation transmitted by the waveguide device.

As may be seen from the theoretical discussion above, suitable ratios of cross-sectional width w to ridge thickness h and of slab thickness t to ridge thickness h may be determined for a given choice of material for the core 802 and buffer layer 804 or substrate 806. By way of example, where the core layer material 802 is lithium tantalate and the buffer layer material 804 is silicon dioxide, the cross-sectional width w may be between about 0.4 h and about 2 h. The thickness t of the slab portions 807 may be between about 0.5 h and about 0.85 h, preferably between about 0.5 h and about 0.6 h. In some embodiments, the core layer 802 may be less than about 1 micron thick for this choice of core and substrate materials.

In some embodiments it may be desirable to incorporate a Bragg grating into the ridge structure 805 to lock a pump diode/laser or to define a resonance of an optical parametric oscillator (OPO). For example, as shown in FIG. 8E, the device 800 may include a Bragg grating 822 formed near one end of the ridge structure 805 at both ends, or along the entire length. In a preferred embodiment, the Bragg grating 822 is formed at one end. The Bragg grating 822 may be made by etching or otherwise forming a series of channels in the ridge structure running more or less perpendicular to the orientation of the ridge structure.

It is noted that many prior nonlinear waveguide designs use a structure in which n_{subst} is less than n_{core} to define a cutoff effective modal refractive index to assure single-modedness. Examples of such waveguide designs are described, e.g., in U.S. Pat. No. 6,631,231 to Mizuuchi et al, U.S. Pat. No. 7,171,094 to Mizuuchi et al., which also published as US Patent Application Publication 20060109542. U.S. Pat. No. 7,171,094 describes a solution to the single-modedness problem for MgO:LN ridge waveguides using multiple “side” ridges that are optically coupled to the main waveguide ridge via a specified range of distances or sizes. High-order (particularly lateral high-order) modes couple to lossy zones under the side ridges more strongly than the fundamental mode. U.S. Pat. No. 6,631,231 does not mention the value of a high vertical V# and instead discusses, inter alia, that single-modedness can be achieved conventionally using low V#. Although such a design puts no constraint on the substrate index, it highly constrains both the waveguide size and the index step to be small.

U.S. Pat. No. 5,703,989 to Khan discloses a complex single mode rib waveguide structure involving many layers of semiconductor materials. The multi-layered structure is designed to support a single mode that closely matches a single-mode fiber in both size and in symmetry. Richard A. Soref, in “Large Single-Mode Rib Waveguides in GeSi—Si and Si-on-SiO₂”, IEEE Journal of Ouantum Electronics, Vo. 27, No. 8, August 1991, pp 1971-1974 describes a ridge-type waveguide restricted to a single-wavelength. Lossy (quasi-) modes and ferroelectric core materials are not discussed.

Prior waveguide configurations that rely on low V# for single-moded operation are often unsuitable, e.g., where the core layer 802 uses a nonlinear material that has a high optical power handling capability, such as stoichiometric lithium tantalate (SLT). For example, Y. Nishida, et. al., “O-dB Wavelength Conversion Using Direct-Bonded QPM-Zn:LiNbO3 Ridge Waveguide”, IEEE Photonics Tech. Lett., vol 17, No 5, pg. 1049, May 2005 describes QPM interactions in a single-mode waveguide with a Zn-doped core and a Mg-doped substrate, using “direct bonding” without any air gap or other intervening material/layer. To achieve single-moded operation a small index step (˜0.4%) between the core and substrate allowed the waveguide to be made relatively thick (6.2 um), while still keeping the V# small enough to assure single-modedness via conventional considerations. The Nishida waveguide design did not rely on any details of the ridge depth/width to produce single-modedness. An SLT core is not compatible with the waveguide described by Nishida et al. due to the low index of SLT material. Furthermore, in the Nishida waveguide design, the wavelength determines a limited range of thicknesses that can be both single-mode, and guided.

Consequently, the Nishida design cannot simultaneously work for a wide range of wavelengths. The Nishida design is also fundamentally an asymmetric design, which is poor for mode overlap. In addition, the Nishida waveguide produces only a modest degree of optical confinement and must be made relatively long in order to achieve a desired wavelength conversion efficiency.

### EXAMPLES

In embodiments of the present invention most instructive parameters for detailed numerical study are primarily the etch depth (h-t) of the ridge 805 and, secondarily, the ridge width w. To demonstrate onset of various high-order modes, with respect to ridge etch depth, a nominal design (5-um core thickness, SLT core layer 802, SiO₂ cladding) with a wider-than-optimal (for the 920-nm wavelength chosen) ridge width of 5 microns is simulated. This wide ridge increased the number of vertical high-order modes present. Once an optimal range for ridge etch depths was determined, the ridge width was varied to demonstrate that various vertical high-order modes could be cut-off by sufficiently reducing the lateral V# via narrowing the ridge width. Rather than impose an application-specific criterion for considering a mode to be guided or not guided, the propagation loss was numerically calculated for the guided fundamental mode (zero loss) and for a group of lower-order guided or quasi-guided (finite loss) modes. Using the mode numbering scheme described above, the effect of ridge etch depth on the loss of each particular mode was determined. As discussed above, as the ridge etch depth is increased, the “simple” high-order modes become less favored, while the “compound” high-order modes become relatively more favored (though they may still be highly lossy). Hence, to simplify the presentation below, simple and compound modes were lumped together and grouped by the number of nulls (zero-crossings) under the ridge. Generally, only one mode existed for each number of nulls. In the few cases where two modes existed, the simple mode and the compound mode had similar losses and similar appearances, making it difficult to unambiguously name them. However, the naming convention is considerably less important than the loss and existence of a mode.

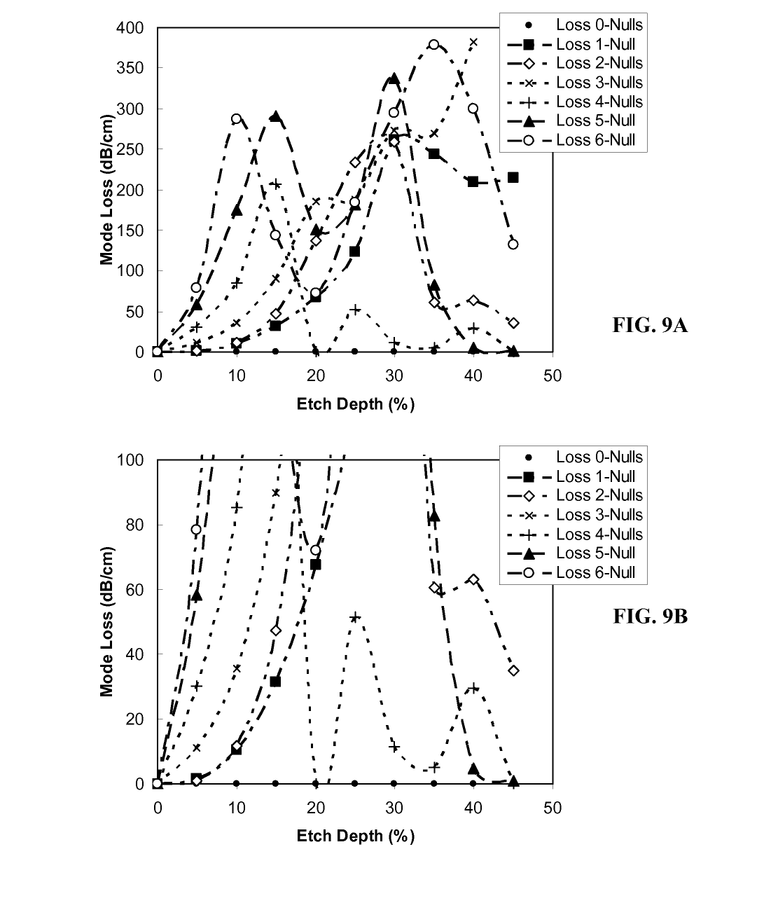

FIGS. 9A and 9B are graphs showing the Mode Loss of seven different mode groups as a function of etch depth. FIG. 9B is simply a rescaled version of FIG. 9A. The fundamental mode is labeled “Loss 0-Nulls”, and has zero loss for all finite etch depths. All high-order modes start with low loss (for shallow etch depths), but rapidly increase in loss, more rapidly for the higher-order modes. Each order of mode eventually reaches a maximum loss value, and then begins to become less lossy (possibly due to the transition between simple and compound high-order modes). Some high-order compound modes (i.e. 4 Nulls at 35% etch depth, and 5 Nulls at 50% etch depth) can be very low loss for poorly chosen waveguide designs. However, there is a large region of design space between about 15% and about 25% etch depth, for which no high-order mode has a loss below about 30 dB/cm, a value sufficiently high that the mode is effectively “not guided” for most applications.

It is clear that the acceptable range of etch depths depends on the required level of loss for high-order modes. Also note that both of these figures assumed a 920-nm wavelength, and the waveguide parameters mentioned above. It should be appreciated that changing any of the other parameters will slightly affect the shape of the above graphs, and will shift the optimum etch depth slightly. However, the ridge width w has a greater effect than the other parameters, as discussed in more detail below:

TABLE I

| | 20% Depth | | 30% Depth | |
|---|---|---|---|---|
| Ridge Width | Mode # | Loss | Mode # | Loss |
| 3 microns | (4 + 5) | 39 dB/cm | (2 + 3) | 9 dB/cm |
| 4 microns | None found | None found | None found | None found |
| 5 microns | (1 + 1) | 64 dB/cm | (3 + 4) | 12 dB/cm |

Table I above shows the results of simulation of six cases of interest. Three values of ridge width w (3 microns, 4 microns and 5 microns) were chosen to demonstrate the impact of ridge width on the mode-selection effects discussed above. In Table I, etch depth is expressed in terms of a percent of the etch depth h-t relative to the ridge thickness h. Two etch depths were chosen: 20% represents a near-optimal value from the above graphs, while 30% represents a less preferred design from the above graphs. In each case considered, most possible high-order modes were either highly lossy, or not found. For each case, the high-order mode with the lowest loss is recorded in Table I. Note that for 4 micron wide ridges, no high-order modes were found, even though the numerical algorithm used was capable of identifying modes with >300 dB/cm of loss (far beyond any reasonable definition of “guided”.) Also note that the 20% depth gave much higher loss values for the modes that were found, as compared with 30% depth (this would be expected from the graphs above.)

It may also be seen from Table I that the ridge width w plays a role in determining which (vertical) high-order mode has the lowest loss. Finally, it should be apparent that a 4-μm wide and 20% deep ridge is a fairly robust design that enables effectively single-moded operation at 920 nm.

Given the large number of parameters that play a role in the mode-selection process, and the large number of potential transverse modes to consider, an exhaustive numerical simulation is required to identify exactly which high-order modes may have the lowest loss for any given detailed waveguide design. However, what is most important is that the lowest-loss high-order modes do have sufficiently high losses. For many applications, the loss values shown in Table I above, and the graphs in FIGS. 9A-9B above are sufficiently high to be ignored. Hence, the general principles outlined above may be used to motivate a range of parameters that result in robustly single-moded waveguides.

Desirable Ranges for Each Parameter.

Based on the mechanisms described above, and based on numerical modeling of many cases, it is clear that many design parameters have optimal ranges—for achieving single-mode operation. Assuming a LiTaO₃ core layer 802 and a SiO₂ buffer layer 804, ridge thickness h may be between about 2 microns and about 10 microns, preferably between about 2 microns and about 7 microns, more preferably between about 3 microns and about 5 microns. Ridge etch depths (h-t) may be between about 15% and about 35% of h, preferably between about 20% and about 25% of h. It is desirable for ridge width w to be similar to the ridge height h (e.g., within a factor of 2x: 0.5 h≦w≦2 h). The sidewall angles θ₁, θ₂ may be greater than about 45 degrees, e.g., between about 45 degrees and about 90 degrees, preferably greater than about 70 degrees.

In certain embodiments of the present invention, the waveguide device 800 may be used as a nonlinear-optical waveguide. Since nonlinear-optical waveguides are often used with a wide range of wavelengths, it is desirable for the waveguide device 800 to provide for single-modedness over a desired wavelength range (e.g., a material transparency range, a range of wavelengths involved in an interaction taking place in the waveguide, a range of wavelengths launched into the waveguide, a widest range possible, etc . . . ). The advantage of high-V# vertical confinement, as described above, is that mode shapes and effective indices do not depend on wavelength (except to the extent that material dispersion is significant.) Hence, a geometry that (via mode overlap integral mechanisms) suppresses a particular high-order mode for one wavelength will also do so for another wavelength. Therefore, wavelength is more of a 2^{nd}-order effect, than a 1^{st}-order effect, with the waveguide device 800. Nonetheless, wavelength is not completely unimportant. The primary reasons why wavelength matters in the waveguide device 800 are: (1) The vertical V# depends on wavelength—and it must be large for all wavelengths involved, (2) The number of simple and compound high-order mode combinations that must be eliminated in order to assure single-modedness also depends on wavelength, and most importantly (3) the effective lateral V# of the ridge depends on wavelength. For long wavelengths, criterion (1) becomes important. While in principle, it is possible to allow for a very low vertical V# for the longest wavelength of interest (thereby assuring single-modedness by known-in-the-art mechanisms), this approach may generally not result in a sufficiently large V# for the intermediate or (possibly) short wavelengths to assure simultaneous single-modedness via the mechanisms described herein. For short wavelengths, criterion (3) becomes important—as the shortest wavelength determines the maximum ridge width that can cut-off the vertical high-order modes at this wavelength. This maximum ridge width may not present adequate confinement for the fundamental modes of all of the longer wavelengths present in the device. While this problem does not result in cut-off of desired fundamental modes, it can adversely impact the overlap integral associated with the nonlinear optical interaction.

While the region defined by the ridge 805 acts as a single-mode waveguide, the slab-like regions 807 away from the ridge 805 may support multiple vertical transverse modes (18 in the example above). If the slab region 807 is finite, (as opposed to infinite) as may be expected for any physically realizable device, then one would also expect lateral mode structure for light guided within this slab region. However, all such transverse modes may be expected to “avoid” the ridge region (due to orthogonality of modes in the full device 800.)

When light is launched into a single-mode high-V# ridge waveguide of the design described above, the portion of light that does not overlap perfectly with the fundamental mode of the structure will partially couple into the guided slab-region modes. This coupling may be small due to the poor overlap integral between these modes and a launch field that primarily contains power near the ridge. As the slab region width is increased, this coupling/overlap may be expected to approach zero (as would be expected for an infinitely wide slab.) However, the total power contained in all of these slab-modes can be significant, particularly if the incident field has a poor overlap with the fundamental mode under the ridge 805. Also, when light is launched into a single-mode high-V# ridge waveguide of the design described above, the portion of light that does not overlap perfectly with the fundamental mode of the structure will partially couple into the highly-lossy, high-order ridge-guided modes that were described in detail above. Light that is launched into these modes will decay rapidly with increasing propagation distance. Hence, while the initial launch field will resemble the incident field, it will rapidly decay into a superposition of the fundamental ridge-guide mode with a collection of high-order slab modes. This results in a complex field distribution if the entire structure is considered, though it results in a simple field distribution if only near the ridge-guiding region is considered.

Example of Multi-Wavelength, Single-Moded Waveguide Design.

Experiments were performed to determine the mode behavior for multiple wavelengths in a waveguide device of the type described above. A 5-micron thick LiTaO3 core, with 3.5-micron wide ridge, with 20% (1 micron) etch depth, with vertical (90 degree) sidewalls was numerically modeled. The wavelengths 920 nm, 1064 nm, 1250 nm, 1550 nm, 2000 nm, and 3500 nm were simulated. A waveguide that is single-moded at all of these wavelengths may be useful for a wide range of OPO devices, and thus is a harsh test-case of embodiments of the present invention.

For each wavelength, other than the fundamental guided mode, only three quasi-guided and lossy quasi-modes were found. These modes exhibited 1, 5, and 6 nulls in the vertical direction, under the ridge. These same modes were present for each of the wavelengths considered, and the mode shapes and sizes were roughly similar for all wavelength considered. The only exception is that for the longest wavelength considered (3500 nm), only the lowest-order (1 null) mode was found—which is not surprising.

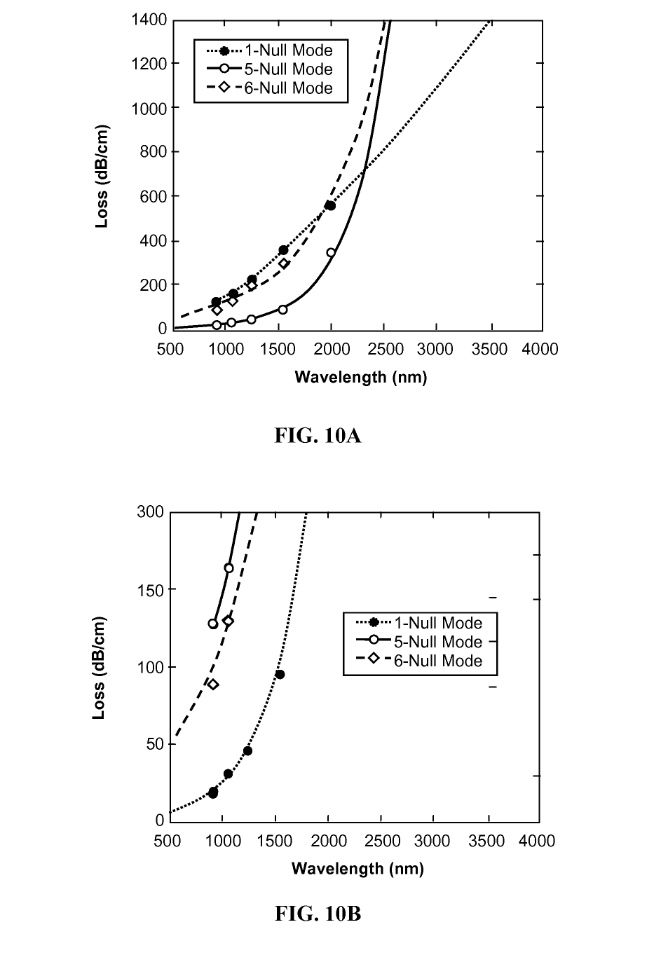

FIGS. 10A-10B are graphs showing the loss associated with each of three high-order quasi-modes as a function of wavelength. FIG. 10B is an expanded-scale version of the FIG. 10A. Note the smooth wavelength dependence of loss. As an aide to the eye, an exponential curve-fit was used to extrapolate the higher-order modes beyond where the numerical simulation produced data. The lowest-loss of the three modes is the 5-Null mode, while the highest loss of the three modes is the lowest-order (1-Null) mode. Also note that all of these modes have moderately high loss for all wavelengths. The conclusion that can be drawn from this analysis is that the design considered is a very robust, wavelength independent, single-mode waveguide characterized by good spatial overlaps between the fundamental modes over a wide range of wavelengths. Such wide-bandwidth single-modedness in high-V# structures is a surprising result in view of the prior art which suggests that a low-V# design is needed in order to achieve single-modedness.

Experiment:

Ridge waveguides were fabricated using Stoichiometric Lithium Tantalate as the core material, SiO₂ as the bottom-cladding material 814, a 1-micron thick bottom cladding layer 804, a Congruent Lithium Tantalate substrate 806, a 5-micron thick core layer (under the ridge) 802, with a 1.5-micron etch depth, 70 degree sidewall angle. Various device lengths from 5 mm to 20 mm were tested. Testing was performed at 1064 nm by end-launching a focused beam. For well-aligned inputs, a clear fundamental mode was visible under the ridge of the waveguide. For small (˜1 micron) misalignments, relative to optimal, the same fundamental mode was visible, but at lower intensity than for the optimally aligned case. No visible distortion of the mode was observed, indicating that no high-order modes with significant power near the ridge of the waveguide were exiting the structure. Since the alignment condition would have excited any such modes, it was concluded that such modes either did not exist, or had sufficiently high losses that no high-order mode light made it to the end of the waveguide.

For larger misalignments, clear excitation of “slab modes” that were vertically guided by the ridge region were observed. When not launching into the fundamental mode under the ridge, the intensity pattern visible at the output facet of the waveguide sample was highly sensitive to launch condition, as is expected for a highly multi-moded structure. However, a localized dark region was observed under the ridge—implying that the slab modes do not have power in the vicinity of the fundamental mode of the ridge. Hence, a clean fundamental mode could be launched under the ridge, or uncontrolled power could be launched into the slab, where the ridge had no effect on either lateral or vertical guiding. For practical applications, this behavior may be regarded as being effectively single-mode.

In a subsequent experiment, a similar waveguide, but with a 9-micron thick core 802 (rather than 5 micron) was fabricated. This structure supported several transverse modes under the ridge. It was difficult to launch efficiently into the fundamental mode of this structure because most launch conditions coupled significant power into the nearby high-order transverse modes. The intensity distribution at the output facet of the device was complex and difficult to control. Hence, it was observed that a device fabricated in violation of the design rules detailed above did not behave in a single-moded fashion. Rather, it behaved like a multi-transverse-moded waveguide, as would normally be expected for a high-V# structure typical of the prior art. This set of experiments demonstrated that (1) a single-mode waveguide may be fabricated using a ridge on a high-V# slab, and that (2) such geometries do not result in single-mode operation if they do not meet the design rules set forth herein.

Waveguide devices fabricated in accordance with embodiments of the present invention may have an IR-visible conversion efficiency of about 40% to 60% or even higher and may produce an average frequency-converted power (e.g., in the visible portion of the spectrum) of 100 mW up to and potentially beyond 30 Watts. Generally, the cross-section of the waveguide device may be chosen for the desired power level. It is further noted that waveguide devices fabricated in accordance with embodiments of the present invention may be stable for long periods of time, e.g., for 10,000 hours or more or even 50,000 hours or more.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. An optical waveguide device, comprising:
a substrate made of a first material;
a core layer made of a second material, the core layer having a first surface and a second surface, wherein the core layer includes a ridge structure at the first surface of the core layer, the ridge structure being characterized by a cross-sectional width w and a thickness h relative to the second surface, the core layer further having one or more slab portions adjacent the ridge structure, the slab portions being characterized by a thickness t between the first surface and the second surface of the core layer, wherein t is less than h, and wherein the ridge structure is characterized by first and second sidewalls;
a buffer layer disposed between the substrate and the core layer, wherein the buffer layer is made of a third material characterized by an index of refraction n_{buff} that is less than n_{core}, and wherein the first material is either optically non-transparent or has an index of refraction, n_{subst} that is greater than or equal to n_{core}
wherein the first material, n_{core}, n_{buff}, h, t and w are selected such that the optical waveguide device is characterized by low loss for a fundamental mode and high loss for higher order modes, wherein the high loss is sufficiently high that the waveguide is effectively single-moded.

2. The device of claim 1 wherein the first material, n_{core}, n_{buff}, h, t and w are selected such that the optical waveguide device supports a single transverse mode and, wherein a portion of the waveguide device under the ridge structure has a vertical V# larger than about π/2, when approximated as a slab waveguide of thickness h.

3. The device of claim 1 wherein the first material, n_{core}, n_{buff}, h, t and w are selected such that the optical waveguide device acts as a waveguide that supports a single transverse mode over a wavelength range from a shortest wavelength of interest λₘᵢₙ to a longest wavelength of interest λₘₐₓ, wherein λₘₐₓ is at least twice as large as λₘᵢₙ.

4. The device of claim 1 wherein the second material is a nonlinear optical material.

5. The device of claim 1 wherein the second material is a ferroelectric material.

6. The device of claim 1 wherein the second material is a stoichiometric lithium tantalate.

7. The device of claim 6 wherein the stoichiometric lithium tantalate has an iron content of less than one part per million (ppm).

8. The device of claim 1 wherein the second material is lithium tantalate doped with a material selected from the group of magnesium oxide, zinc oxide and yttrium oxide.

9. The device of claim 8 wherein the lithium tantalate is doped with magnesium oxide to a concentration of between about 5% and about 7%.

10. The device of claim 1 wherein the second material is a quasi phase-matched lithium tantalate material.

11. The device of claim 10 wherein the first material is a congruent lithium tantalate material.

12. The device of claim 1 wherein the first material is an electrically conductive material.

13. The device of claim 1 further comprising an electrically conductive film coating a surface of the buffer layer and/or substrate.

14. The device of claim 1 wherein the second material is a ferroelectric material that includes one or more patterned domains.

15. The device of claim 1 wherein the second material has a radiation-induced absorption coefficient that is less than about 0.1/Watt.

16. The device of claim 1 wherein the second material has a radiation-induced absorption coefficient that is less than about 0.01/Watt.

17. The device of claim 1 wherein the second material has a radiation-induced absorption coefficient that is less than about 0.001/Watt.

18. The device of claim 1 wherein w, h and t are chosen to provide an average optical field intensity of between about 1 MW/cm² and about 100 MW/cm² for a designated input power.

19. The device of claim 1 wherein measured variations in the thickness h of the core material layer are compensated by variations in the width w of the ridge structure to maintain constant phase velocity or group velocity matching in the waveguide device.

20. The device of claim 1 wherein the buffer layer is sufficiently thick that light guided in the core is not significantly coupled to the substrate.

21. The device of claim 20 wherein the buffer layer is characterized by a thickness that exceeds a longest wavelength to be guided by the waveguide device.

22. The device of claim 1 wherein the first material is thermally conductive and has a coefficient of thermal expansion that matches a thermal expansion coefficient of the second material.

23. The device of claim 22 wherein the first material is copper, a copper-containing material or CuₓW_{y}, where x ranges between about 0.1 and about 0.9 and y=1−x.

24. The device of claim 23 wherein the second material is lithium tantalate.

25. The device of claim 1 wherein the first and second sidewalls are respectively oriented at angles θ₁ and θ₂ relative to the first surface of the core layer, wherein the angles θ₁ and θ₂ are between about 45° and about 90°.

26. The device of claim 1 wherein the ridge structure is characterized by a length between about 1 mm and about 50 mm.

27. The device of claim 26 wherein the ridge structure is characterized by a length between about 5 mm and about 30 mm.

28. The device of claim 1, further comprising a layer of material coating a bottom surface of the substrate, wherein the layer of material is characterized by an index of refraction that is less than n_{subst}.

29. The device of claim 1 wherein h is less than or equal to about 5 microns.

30. The device of claim 1 wherein h is greater than about 1 micron.

31. The device of claim 1 wherein h is between about 2 microns and about 10 microns.

32. The device of claim 1 wherein h is between about 3 microns and about 5 microns.

33. The device of claim 1 wherein an etch depth h-t is between about 15% and about 35% of h.

34. The device of claim 1 wherein w is within a factor of 2 of h.

35. The device of claim 1 wherein first surfaces of the slab portions of the core layer are of substantially uniform thickness in regions extending from the sidewalls of the ridge structure to edges of the core layer.

36. The device of claim 1 wherein the second material is lithium tantalate and the third material is silicon dioxide or aluminum oxide.

37. The device of claim 36 wherein h is between about 2 microns and about 7 microns, wherein w is between about 0.4 h and about 2 h, wherein t is between about 0.5 h and about 0.85 h.

38. The device of claim 36 wherein h is between about 3 microns and about 5 microns.

39. The device of claim 36 wherein t is between about 0.5 h and about 0.6 h.

40. The device of claim 36 wherein h is greater than about 1 micron.

41. The device of claim 1 wherein the substrate is less than about 500 microns thick.

42. The device of claim 1 wherein the substrate is less than about 250 microns thick.

43. The device of claim 1 wherein the substrate is less than about 100 microns thick.

44. The device of claim 1 wherein
$$t > \frac{λ}{\sqrt{{n}_{core}^{2} - {n}_{buff}^{2}}} ,$$
where λ is a shortest wavelength of interest for radiation transmitted by the waveguide device.

45. The device of claim 1 wherein h, n_{core} and n_{buff} are selected such that a vertical V# for a slab waveguide of thickness h is greater than about π for a longest wavelength of interest, wherein an index step for the slab waveguide is defined using an effective index approximation.

46. The device of claim 1 wherein w, h, n_{core}, t and n_{buff} are selected such that a lateral V# for a slab waveguide of thickness w is less than or equal to about π/2 for a longest wavelength of interest, wherein an index step for the slab waveguide is defined using an effective index approximation.

47. The device of claim 1 wherein h, t and w are chosen such that the device provides a substantially constant mode height and mode width at two or more wavelengths of interest.

48. The device of claim 1 wherein h, t and w are chosen to maximize an overlap integral between fundamental modes of two or more interacting wavelengths of interest for the device.

49. The device of claim 1, further comprising a Bragg grating incorporated into the ridge structure.

50. The device of claim 1 wherein w is less than or equal to t.

51. The device of claim 50 wherein w is about 3 to 8 times wider than a wavelength for radiation launched into the waveguide device.

52. The device of claim 51 wherein w is about 4 to 16 times wider than a shortest wavelength of interest to be guided by the waveguide device.

53. An optical waveguide device, comprising:
a core layer made of a ferroelectric first material characterized by a refractive index n_{core}, wherein the core layer is characterized by a substantially uniform thickness t, except for a ridge region characterized by a cross-sectional width w and a thickness h, wherein t is less than h, and wherein the ridge region includes a ridge structure having first and second sidewalls; and
a buffer layer disposed on a surface of the core layer, wherein the buffer layer is made of a second material characterized by an index of refraction n_{buff} that is less than n_{core} wherein the first material, n_{core}, n_{buff}, h, t and w are selected such that the optical waveguide device is characterized by low loss for a fundamental mode and high loss for higher order modes, wherein the high loss is sufficiently high that the waveguide is effectively single-moded.

54. The device of claim 53 wherein n_{core}, n_{buff}, h, t and w are selected such that the optical waveguide device supports a single transverse mode and, wherein a portion of the waveguide device under the ridge structure has a vertical V# larger than about π/2, when approximated as a slab waveguide of thickness h for a longest wavelength of interest and with the approximation that the slab waveguide has infinite width.

55. The device of claim 53 wherein n_{core}, n_{buff}, h, t and w are selected such that the optical waveguide device acts as a waveguide that supports a single transverse mode over a wavelength range from a shortest wavelength of interest λₘᵢₙ to a longest wavelength of interest λₘₐₓ, wherein λₘₐₓ is at least twice as large as λₘᵢₙ.

56. The device of claim 53 wherein the first material is a nonlinear optical material.

57. The device of claim 53 wherein the first material is a stoichiometric lithium tantalate.

58. The device of claim 53 wherein the second material is lithium tantalate doped with a material selected from the group of magnesium oxide, zinc oxide and yttrium oxide.

59. The device of claim 58 wherein the lithium tantalate is doped with magnesium oxide to a concentration of between about 5% and about 7%.

60. The device of claim 53 wherein the first material is a quasi phase-matched lithium tantalate material.

61. The device of claim 53, further comprising a substrate made of a third material, wherein the buffer layer is disposed on a surface of the substrate such that the buffer layer is between the surface of the core layer and the surface of the substrate.

62. The device of claim 61 wherein the substrate is characterized by an index of refraction n_{subst} that is greater than or equal to n_{core}.

63. The device of claim 62, further comprising a layer of material coating the bottom surface of the substrate, wherein the layer of material is characterized by an index of refraction that is less than n_{subst}.

64. The device of claim 61 wherein the third material is a congruent lithium tantalate material.

65. The device of claim 61 wherein the buffer layer is sufficiently thick that light guided in the core is not significantly coupled to the substrate.

66. The device of claim 61 wherein the third material is thermally conductive and has a coefficient of thermal expansion that matches a thermal expansion coefficient of the first material.

67. The device of claim 53 wherein the first and second sidewalls are respectively oriented at angles θ₁ and θ₂ relative to the first surface of the core layer, wherein the angles θ₁ and θ₂ are between about 45° and about 90°.

68. The device of claim 53 wherein the ridge structure is characterized by a length between about 1 mm and about 50 mm

69. The device of claim 68 wherein the ridge structure is characterized by a length between about 5 mm and about 30 mm.

70. The device of claim 53 wherein h is less than or equal to about 5 microns.

71. The device of claim 53 wherein h is between about 2 microns and about 10 microns.

72. The device of claim 53 wherein h is between about 3 microns and about 5 microns.

73. The device of claim 53 wherein the first material is lithium tantalate and the second material is silicon dioxide or aluminum oxide.

74. The device of claim 73 wherein h is between about 2 microns and about 7 microns, wherein w is between about 0.5 h and about 2 h, wherein t is between about 0.5 h and about 0.85 h.

75. The device of claim 74 wherein h is between about 3 microns and about 5 microns.

76. The device of claim 72 wherein t is between about 0.5 h and about 0.6 h.

77. The device of claim 53 wherein
$$t > \frac{λ}{\sqrt{{n}_{core}^{2} - {n}_{buff}^{2}}} ,$$
where λ is a shortest wavelength of interest for radiation transmitted by the waveguide device.

78. The device of claim 53 wherein h, n_{core} and n_{buff} are selected such that a vertical V# for a slab waveguide of width w and thickness h is greater than about π for a longest wavelength of interest.

79. The device of claim 53 wherein w, h, n_{core} and n_{buff} are selected such that a lateral V# for a slab waveguide of thickness w is less than or equal to about π/2 for a longest wavelength of interest, wherein an index step for the slab waveguide is defined using an effective index approximation.

80. The device of claim 53 wherein h, t and w are chosen such that the device provides a substantially constant mode height and mode width at two or more wavelengths of interest.

81. The device of claim 53 wherein w is less than or equal to t.

82. The device of claim 81 wherein w is about 3 to 8 times wider than a wavelength of radiation launched into the waveguide device.

83. The device of claim 82 wherein w is about 4 to 16 times wider than a shortest wavelength of interest to be guided by the waveguide device.

84. An optical waveguide device, comprising:
a substrate made of a first material;
a core layer made of a ferroelectric second material, the core layer having a first surface and a second surface, wherein the core layer includes a ridge structure at the first surface of the core layer, the ridge structure being characterized by a cross-sectional width w and a thickness h relative to the second surface, the core layer further having one or more slab portions adjacent the ridge structure, the slab portions being characterized by a thickness t between the first surface and the second surface of the core layer, wherein t is less than h, and wherein the ridge structure is characterized by first and second sidewalls; and
a buffer layer disposed between the substrate and the core layer, wherein the buffer layer is made of a third material characterized by an index of refraction n_{buff} that is less than an index of refraction n_{core} of the core layer,
wherein the first material, n_{core}, n_{buff}, h, t and w are selected such that the optical waveguide device is characterized by low loss for a fundamental mode and high loss for higher order modes, wherein the high loss is sufficiently high that the waveguide is effectively single-moded.

85. The device of claim 84 wherein the buffer layer is sufficiently thick that light guided in the core is not significantly coupled to the substrate.

86. The device of claim 85 wherein the buffer layer is characterized by a thickness that exceeds a longest wavelength present.

87. The device of claim 84 wherein the first material is either optically non-transparent or has an index of refraction, n_{subst} that is greater than or equal to n_{core} an index of refraction n_{core} of the core layer.

88. The device of claim 84 wherein the first material, n_{buff}, n_{core}, h, t and w are selected such that the optical waveguide device supports a single transverse mode and, wherein a portion of the waveguide device under the ridge structure has a vertical V# larger than about π/2, when approximated as a slab waveguide of thickness h.

89. The device of claim 84 wherein the first material, n_{core}, h, t and w are selected such that the optical waveguide device acts as a waveguide that supports a single transverse mode over a wavelength range from a shortest wavelength of interest λₘᵢₙ to a longest wavelength of interest λₘₐₓ, wherein λₘₐₓ is at least twice as large as λₘᵢₙ.

90. The device of claim 84 wherein the second material is a nonlinear optical material.

91. The device of claim 84 wherein the second material is a ferroelectric material.

92. The device of claim 84 wherein the second material is a stoichiometric lithium tantalate.

93. The device of claim 92 wherein the stoichiometric lithium tantalate has an iron content of less than one part per million (ppm).

94. The device of claim 84 wherein the second material is lithium tantalate doped with a material selected from the group of magnesium oxide, zinc oxide and yttrium oxide.

95. The device of claim 94 wherein the lithium tantalate is doped with magnesium oxide to a concentration of between about 5% and about 7%.

96. The device of claim 84 wherein the second material is a quasi phase-matched lithium tantalate material.

97. The device of claim 96 wherein the first material is a congruent lithium tantalate material.

98. The device of claim 84 wherein the first material is an electrically conductive material.

99. The device of claim 84 further comprising an electrically conductive film coating a surface of the buffer layer and/or substrate.

100. The device of claim 84 wherein the second material includes patterned domains.

101. The device of claim 84 wherein the second material has a radiation-induced absorption coefficient that is less than about 0.1/Watt.

102. The device of claim 84 wherein the second material has a radiation-induced absorption coefficient that is less than about 0.01/Watt.

103. The device of claim 84 wherein the second material has a radiation-induced absorption coefficient that is less than about 0.001/Watt.

104. The device of claim 84 wherein w, h and t are chosen to provide an average optical field intensity of between about 1 MW/cm² and about 100 MW/cm² for a designated input power.

105. The device of claim 84 wherein measured variations in the thickness h of the core material layer are compensated by variations in the width w of the ridge structure to maintain constant phase velocity or group velocity matching in the waveguide device.

106. The device of claim 84 wherein the first material is thermally conductive and has a coefficient of thermal expansion that matches a thermal expansion coefficient of the second material.

107. The device of claim 106 wherein the first material is copper, a copper-containing material or CuₓW_{y}, where x ranges between about 0.1 and about 0.9 and y=1−x.

108. The device of claim 107 wherein the second material is lithium tantalate.

109. The device of claim 84 wherein the first and second sidewalls are respectively oriented at angles θ₁ and θ₂ relative to the first surface of the core layer, wherein the angles θ₁ and θ₂ are between about 45° and about 90°.

110. The device of claim 84 wherein the ridge structure is characterized by a length between about 1 mm and about 50 mm.

111. The device of claim 110 wherein the ridge structure is characterized by a length between about 5 mm and about 30 mm.

112. The device of claim 84, further comprising a layer of material coating a bottom surface of the substrate, wherein the layer of material is characterized by an index of refraction that is less than n_{subst}.

113. The device of claim 84 wherein h is less than or equal to about 5 microns.

114. The device of claim 84 wherein h is greater than about 1 micron.

115. The device of claim 84 wherein h is between about 2 microns and about 10 microns

116. The device of claim 84 wherein h is between about 3 microns and about 5 microns

117. The device of claim 84 wherein an etch depth h-t is between about 15% and about 35% of h.

118. The device of claim 84 wherein w is within a factor of 2 of h.

119. The device of claim 84 wherein first surfaces of the slab portions of the core layer are of substantially uniform thickness in regions extending from the sidewalls of the ridge structure to edges of the core layer.

120. The device of claim 84 wherein the second material is lithium tantalate and the third material is silicon dioxide or aluminum oxide.

121. The device of claim 120 wherein h is between about 2 microns and about 7 microns, wherein w is between about 0.4 h and about 2 h, wherein t is between about 0.5 h and about 0.85 h.

122. The device of claim 120 wherein h is between about 3 microns and about 5 microns.

123. The device of claim 120 wherein t is between about 0.5 h and about 0.6 h.

124. The device of claim 120 wherein h is greater than about 1 micron.

125. The device of claim 84 wherein the substrate is less than about 500 microns thick.

126. The device of claim 84 wherein the substrate is less than about 250 microns thick.

127. The device of claim 84 wherein the substrate is less than about 100 microns thick.

128. The device of claim 84 wherein
$$t > \frac{λ}{\sqrt{{n}_{core}^{2} - {n}_{buff}^{2}}} ,$$
where λ is a shortest wavelength of interest for radiation transmitted by the waveguide device.

129. The device of claim 84 wherein h, n_{core} and n_{buff} are selected such that a vertical V# for a slab waveguide of thickness h is greater than about π for a longest wavelength of interest, wherein an index step for the slab waveguide is defined using an effective index approximation.

130. The device of claim 84 wherein w, h, t, n_{core} and n_{buff} are selected such that a lateral V# for a slab waveguide of thickness w is less than or equal to about π/2 for a longest wavelength of interest, wherein an index step for the slab waveguide is defined using an effective index approximation.

131. The device of claim 84 wherein h, t and w are chosen such that the device provides a substantially constant mode height and mode width at two or more wavelengths of interest.

132. The device of claim 84 wherein h, t and w are chosen to maximize an overlap integral between fundamental modes of two or more interacting wavelengths of interest for the device.

133. The device of claim 84, further comprising a Bragg grating incorporated into the ridge structure.

134. The device of claim 84 wherein w is less than or equal to t.

135. The device of claim 134 wherein w is about 3 to 8 times wider than a wavelength for radiation launched into the waveguide device.

136. The device of claim 135 wherein w is about 4 to 16 times wider than a shortest wavelength of interest to be guided by the waveguide device.
